(19) United States
(12) Patent Application Publication
(10) Pub. No.: US 2014/0201091 A1
(43) Pub. Date: Jul. 17, 2014

(54) Quality Control Audit System and Process

(71) Applicant: Chicago Housing Authority, Chicago, IL (US)

(72) Inventors: Rachel Kimball, Chicago, IL (US); Peter Papanikolaou, Munster, IN (US); Boris B. Lee, Chicago, IL (US); Yiyan Chen, Naperville, IL (US)

(21) Appl. No.: 14/155,059

(22) Filed: Jan. 14, 2014

Related U.S. Application Data
(60) Provisional application No. 61/752,282, filed on Jan. 14, 2013.

(51) Int. Cl. G06Q 50/16; G06Q 30/06

(52) U.S. Cl. CPC G06Q 50/163; G06Q 30/0645
USPC 705/307

(57) ABSTRACT

The present invention relates to a quality control audit system and process to an admission and reexamination system for auditing files for individuals entering or living in public or subsidized housing or using a voucher program.

### CROSS-REFERENCE TO RELATED APPLICATIONS

The present application claims the benefit of U.S. Provisional Patent Application No. 61/752,282, filed Jan. 14, 2013, the contents of which are incorporated herein by reference.

### FEDERALLY SPONSORED RESEARCH OR DEVELOPMENT

N/A

### FIELD OF THE INVENTION

This invention generally relates to a computerized quality control audit system and process, and more particularly, to a system for auditing files for individuals entering or living in public or subsidized housing or using a voucher program.

### BACKGROUND TO THE INVENTION

The U.S. Department of Housing and Urban Development (HUD) requires a Form HUD-50058 be filled-out and maintained for collecting, storing, and generating reports on families who participate in Public Housing or Section 8 rental subsidy programs. Quality control auditing or review of such forms is necessary to ensure the quality and accuracy of the information submitted and the proper calculation and collection of rent owed by program participants.

A Form HUD-50058 Report provides HUD with a picture of the people who participate in the subsidized housing programs. Local and Regional Public Housing Authorities (PHAs) collect and electronically submit the information collected and contained on the Form HUD-50058 to HUD. The data collected on the form provides HUD with details of the people who participate in subsidized housing programs. The Public and Indian Housing Information Center (PIC) System then captures this information and creates reports used to: analyze the subsidized housing programs, monitor PHAs, detect fraud, and provide information to Congress and other interested parties.

PHAs are required to submit Form HUD-50058 data at least annually for each household that participates in HUD's Office of Public and Indian Housing (PIH) assisted housing programs. Public Housing Agencies (PHAs) must electronically submit all Form HUD-50058 data to the Inventory Management System (IMS)/PIH Information Center (PIC) System (IMS/PIC). HUD requires complete, accurate and timely submission of Form HUD-50058 data to the IMS/PIC System for effective program monitoring and management.

Important considerations include ensuring the entire Form HUD-50058 is filled-out and the information supplied is accurate and consistent. In the past, this information was typically hand checked manually or by using spreadsheets of cases/individuals and responses (i.e., a manual or spreadsheet comparison of the HUD-50058 form and the participant's document file folder—either a paper or electronic copy—was necessary in order to verify compliance with and ensure correct application of HUD requirements). This was time consuming and subject to human error.

The system and process of the present invention is a quality control tool that integrates with an established Enterprise Resource Planning (ERP-style) system or a property management system used among housing authorities and other property management firms that permits reviewers to input the necessary information and have that information cross-checked for review, correction and eventual acceptance.

### SUMMARY OF THE INVENTION

The present invention is a quality control audit system and process that permits one (e.g., an auditor or reviewer) to efficiently and comprehensively work with the Form HUD-50058 as to inputting, checking, and submitting the necessary information required by HUD and to generate individual reports and overall statistical reports. The system or process will compare and annotate discrepancies between the auditor/reviewer entered or available data and the current HUD-50058 form for a selected tenant. In this manner, the present invention provides a web-based tenant file review system and process to improve the quality and check/confirm the accuracy of the submitted HUD forms.

The invention also provides a system to track and respond to audit/review findings. That is, the system generates electronic messages and reports that are sent to vendors, private property managers, etc., who are then given an opportunity to dispute or correct any resulting discrepancies or findings from an audit. The system or process can docket and keep track of the process to ensure it is completed in a timely manner.

In accordance with one embodiment of the invention, a computerized housing audit system is provided. The system comprises a user computer configured to select a first tenant from a plurality of tenants in a subsidized housing program. The tenant information is stored in a database and/or is controlled by a program in communication with the user computer. The database can be on the user computer or accessible over a network connection, such as the Internet (i.e., a web based application). Each of the plurality of tenants has an associated current electronically stored housing form (e.g., a HUD-50058 form) containing required housing information in the database or another database or memory location. The user computer is further configured to enable a user to initiate an electronic audit of the first tenant. The electronic audit includes obtaining the current housing form containing the required housing information for the first tenant, enabling the user to confirm the accuracy of the required housing information of the first tenant, and generating a report identifying findings from the initiated audit.

The system can be used for different subsidized programs. In particular, the user computer is configured to select one of a Public Housing Audit and a Housing Choice Voucher (HCV)/Property Rental Assistance Audit based on the first tenant selected. Other types of audits are also possible.

The user computer can be configured to enable the user to provide an indication that a select item of the required housing information of the first tenant is one of correct or not correct. For example, the system can download items of information from the current housing form and request the user to indicate whether select items are correct or not correct. This can be done, for example, with a drop down menu. The user computer can also be configured to enable the user to input file information relating to the first tenant and then automatically compare it to items of the required housing information of the current electronically stored housing form to the inputted file information.

The required housing information of the current electronically stored housing form of the first tenant can include an identification of: the property leased by the first tenant, the household of the first tenant, assets of the first tenant, income of the first tenant, and any criminal record of the first tenant. Other types of information can also be included.

The user computer can also be configured to generate and send an electronic message to one of a vendor and private property management (whichever is appropriate for the selected first tenant) of the report identifying findings from the initiated audit. The user computer can also receive an electronic message from the one of a vendor and private property management responding to the report identifying findings from the initiated audit. The responding electronic message can be one of a correction of the required information of the first tenant or a dispute of the inaccuracy of the required information of the first tenant. The messaging can be repeated until all errors are corrected or successfully disputed.

The user computer can also be configured to calculate a tenant rent rate based at least in part on any user inputted file information. It can also be configured to identify requisite supporting documentation for the required information of the first tenant.

In accordance with another embodiment, a computerized process for auditing a subsidized housing program is provided. The housing auditing process comprises providing a user computer in communication with a database of a plurality of current tenant housing forms of a corresponding plurality of tenants in a subsidized housing program. Each tenant housing form contains a plurality of items of information. The process further comprises selecting a first tenant of the plurality of tenants and enabling a reviewer to initiate an electronic audit of the selected first tenant. Once initiated, the process includes obtaining a tenant housing form associated with the selected tenant from the database (i.e., this can be downloaded from a database or through another application used for creating such forms), reviewing the items of information from the obtained tenant housing form and generating a report containing findings of the reviewing step.

The reviewing step can include displaying an item of information from the obtained tenant housing form and receiving an electronic response from the reviewer indicating the selected item is one of correct or incorrect. The reviewing step can also include receiving inputted data from the reviewer and comparing the inputted data against an item of information from the obtained tenant housing form.

The process can also include electronically transmitting the report to one of a vendor and a private property management associated with the tenant and electronically receiving one of a correction and a dispute of the findings in the report. Additionally, the process can include electronically tracking the status of the findings in the report.

Further aspects of the invention are shown in the Figures and described herein.

### BRIEF DESCRIPTION OF THE DRAWINGS

To understand the present invention, it will now be described by way of example, with reference to the accompanying drawings in which:

FIG. 1 is a flow-chart showing the process overview for the auditing system and process of the present invention;

FIGS. 2A-2B are flow-charts showing the process for both a standard new admission and a standard interim reexamination, respectively;

FIGS. 3A-3F are flow-charts showing the process for a new admission or an interim re-examination associated with a housing choice voucher (HCV);

FIGS. 4A-4E are flow-charts showing the process for a new admission associated with a public housing action (PHA);

FIG. 5 is a flow-chart showing the process for an interim reexamination associated with a public housing action (PHA) (absent the identical preceding process steps set forth in FIGS. 4A-4C);

FIG. 6 is a screen shot of a Yardi application for initiating a housing audit in accordance with the present invention;

FIG. 7 is a screenshot of a page identifying a housing unit of an audit of the present system and process;

FIG. 8 is a screenshot of a household page of the present system and process;

FIG. 9 is a screenshot of a tenant assets page of the present system and process;

FIG. 10 is a screenshot of a tenant income page of the present system and process;

FIG. 11 is a screenshot of a total tenant pay page of the present system and process;

FIG. 12 is a screenshot of a public housing and turnkey page of the present system and process;

FIG. 13 is a screenshot of a project based voucher page of the present system and process;

FIG. 14 is a screenshot of an audit checklist page of the present system and process;

FIG. 15 is a screenshot of a 50058 control page of the present system and process;

FIG. 16 is a screenshot of a Section 8 page of the present system and process;

FIG. 17 is a screenshot of a Section 8 calculations page of the present system and process;

FIG. 18 is a screenshot of a criminal history page of the present system and process;

FIG. 19 is a screenshot of a background-drug test page of the present system and process;

FIG. 20 is a screenshot of an audit control page of the present system and process;

FIG. 21 is a screenshot of a continuous quality improvement page of the present system and process;

FIG. 22 is a screenshot of an audit summary page of the present invention;

FIG. 23 is a screenshot of an audit findings page of the present invention;

FIG. 24 is a screenshot of a findings response summary page of the present invention;

FIG. 25 is a screenshot showing a comment in a findings detail page of the present invention;

FIG. 26 is a screenshot of a findings response summary page of the present invention indicating an approved and verified finding;

FIG. 27 are screenshots of an audits finding page of the present invention before approval and after approval; and,

FIG. 28 is a screenshot of an impact detail report generated by the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

As used herein, the following terms and/or acronyms mean:

| Term, Acronym | Definition |
|---|---|
| 50058 | (aka HUD-50058 or Family Report) Data collection form |
| | provided to HUD to provide a snapshot of participants in |
| | subsidized housing programs |
| Action Type | The transaction type for the action being performed (1- |
| | New Admission, 2-annual Reexamination, 3-Interim |
| | Reexamination, etc.). |
| Adjusted income | Anticipated annual income of all members of the family |
| | on the lease after exclusions, allowances and deductions |
| | have been applied |
| CHA | Chicago Housing Authority |
| Child care | Unreimbursed amounts anticipated to be paid by the |
| expenses | family for the care of children under the age of 13. |
| Dependent | A member of the family other than the family head co- |
| | head or spouse who is under 18 years of age, has a |
| | disability, or are full-time students of any age. |
| Disability | Reasonable expenses that are anticipated, during the |
| assistance | period for which annual income is computed for |
| expense | attendant care and auxiliary apparatus for a disabled |
| | family member and that are necessary to enable a family |
| | member (including the disabled member) to be |
| | employed, provided that the expenses are neither paid to |
| | a member of the family nor reimbursed by an outside |
| | source. |
| HAPC | (aka HAP Contract) Housing assistance payments |
| | contract |
| HCV | Housing Choice Voucher: public housing program type |
| HOH | Head of Household; the adult member of the family who |
| | is the head of the household for purposes of determining |
| | income eligibility and rent. |
| Household | Includes everyone who has been approved to live in the |
| | unit |
| HUD | Department of Housing and Urban Development: |
| Mod Rehab | Moderate rehabilitation: public housing program type |
| | providing project-based rental assistance for low |
| | income families |
| PBV | Project Based Voucher: housing type wherein a subsidy |
| | is attached to the unit, |
| P or PH | Public Housing: program type that is assisted by a PHA |
| | with capital or operating assistance |
| PHA | Public Housing Agency: any state, county, municipality, |
| | that is authorized to engage or assist in the development |
| | or operation of low-income housing |
| PPM | Private Property Management (firms responsible for |
| | monitoring/managing CHA owned properties) |
| PRA | Property Rental Assistance: program type wherein multi- |
| | unit housing is leased to the CHA to house clients |
| QC | Quality Control |
| Quality Control | (aka QC Audit) The process of reviewing an applicant or |
| Audit | participant file (either whole or in part) to ensure and |
| | record the accuracy of the HUD 50058 and its supporting |
| | documentation. |
| Quality Control | (aka File reviewer, QC Auditor) HCV, PRA or PH |
| Auditor | employee conducting file review |
| Reasonable rent | Rent to owner that is not more than rent charged for |
| | comparable units |
| Reviewer | System User (same as QC Auditor) |
| Tenant | Person/s residing in subsidized housing |
| TTP or Total | Minimum rent tenant is responsible to pay |
| Rental Payment | |
| UA | Utility allowance |
| Vendor | Company/ies engaged by PRA and HCV programs to |
| | monitor/manage the voucher program |
| VO | Voucher: a document issued by a PHA to a family |
| | selected for admission to the voucher program. |
| Yardi | Web-based, enterprise management system designed for |
| | property owners, managers, and investors in global real |
| | estate markets |

Aspects of the present system and process are illustrated in detail in the Figures. While the Figures and description follow the system and process developed by and for the CHA, it is recognized that it can be adapted and used by other housing authorities and others outside of government.

The present system or process 10 utilizes a housing auditing application. The application 10 is preferably web-based and is accessible over the Internet with a user computer. The system 10 utilizes a Quality Control Audit program or application that downloads or otherwise accesses data from a current HUD-50058 form and enables an auditor or reviewer to compare the downloaded/accessed current form data with file data to determine accuracy of the currently filed HUD form and ensure accurate payments are being made by the tenant. The application can work with and/or be incorporated in other applications currently used for preparation and submission of HUD-50058 forms. For example, the system 10 can be a self-contained web-based application within an existing Yardi Voyager enterprise software product (aka Yardi). In particular, the audit application can be accessed via the pre-existing HUD-50058 form record located on Yardi's Family information page. A selected HUD-50058 form will be used to provide data to populate the baseline sections of the system 10 for review.

The system 10 also enables communication with vendors and others to respond to (e.g., correct or dispute) audit findings (e.g., errors, missing information or documentation, etc.) generated by the system 10. The audit application will compare and enable annotation of discrepancies between auditor entered or available data and the data from the current HUD-50058 form selected from forms stored on the Yardi application. The system will enable the auditor to electronically create findings notices (that can be sent to vendors, etc.) related to the tenant review, and document and track all such findings notices.

In operation, a CHA auditor (sometimes referred to as “reviewer” or “user”) utilizes the system 10 to randomly select a housing tenant for an audit. A Notice of an upcoming audit is sent to a vendor or Private Property Management (PPM) firm associated with the selected tenant. The CHA reviewer retrieves the tenant's file(s) and next opens-up the Quality Control Audit program of the present invention. The Quality Control Audit program can be stored on a local computer, central server, or other network device. The program can further be web-based or cloud-based. The data maintained by the program once entered, can be similarly stored. In the preferred embodiment, the Quality Control Audit program is a web-based application stored on a server.

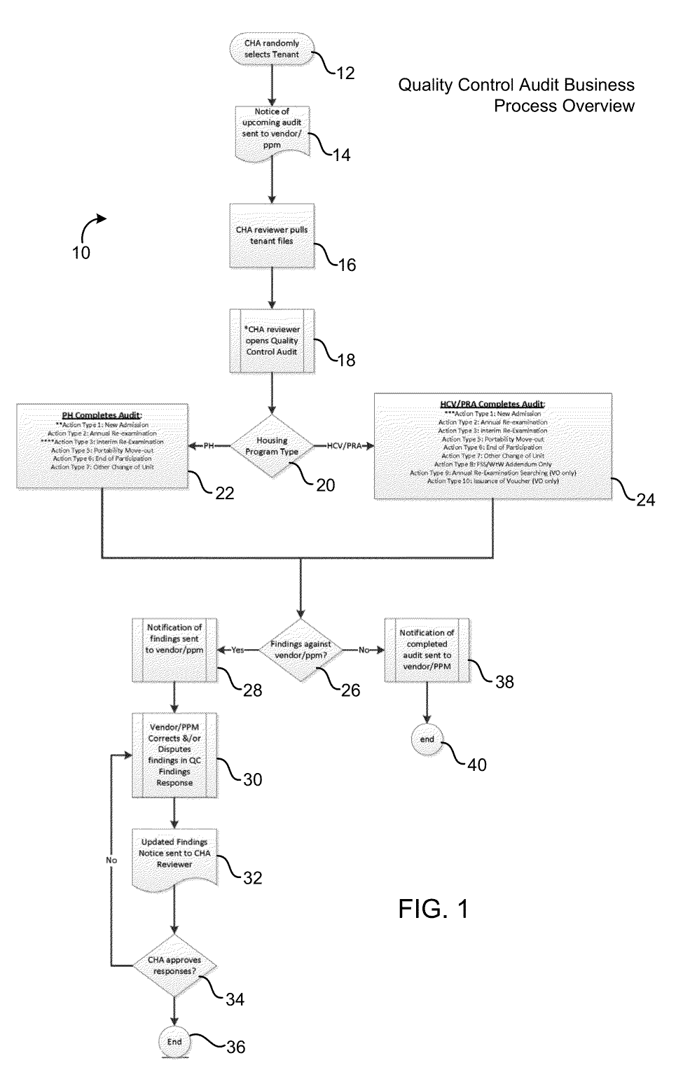

An overview of the operation of the system and process in accordance with one embodiment of the invention is illustrated in FIG. 1. As shown, a tenant (i.e., a HUD program participant) is randomly selected 12 by the system 10. Notice 14 is then provided to the vendor or PPM associated with the selected tenant. The tenant's files are pulled by the auditor 16 and an audit 18 is opened on the system 10.

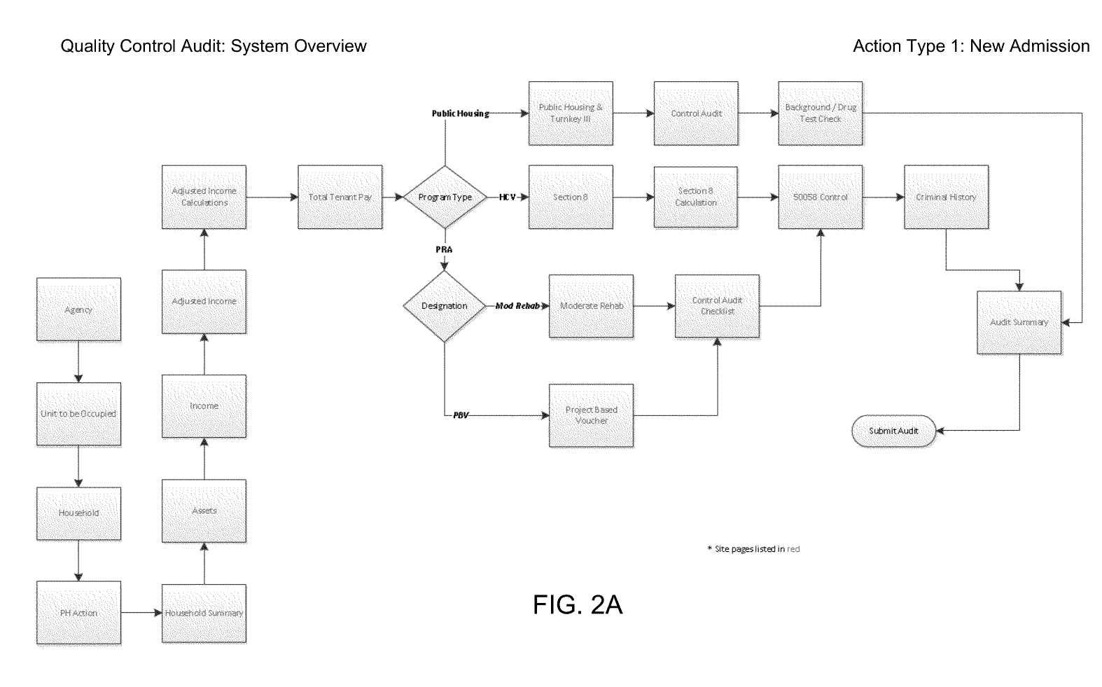

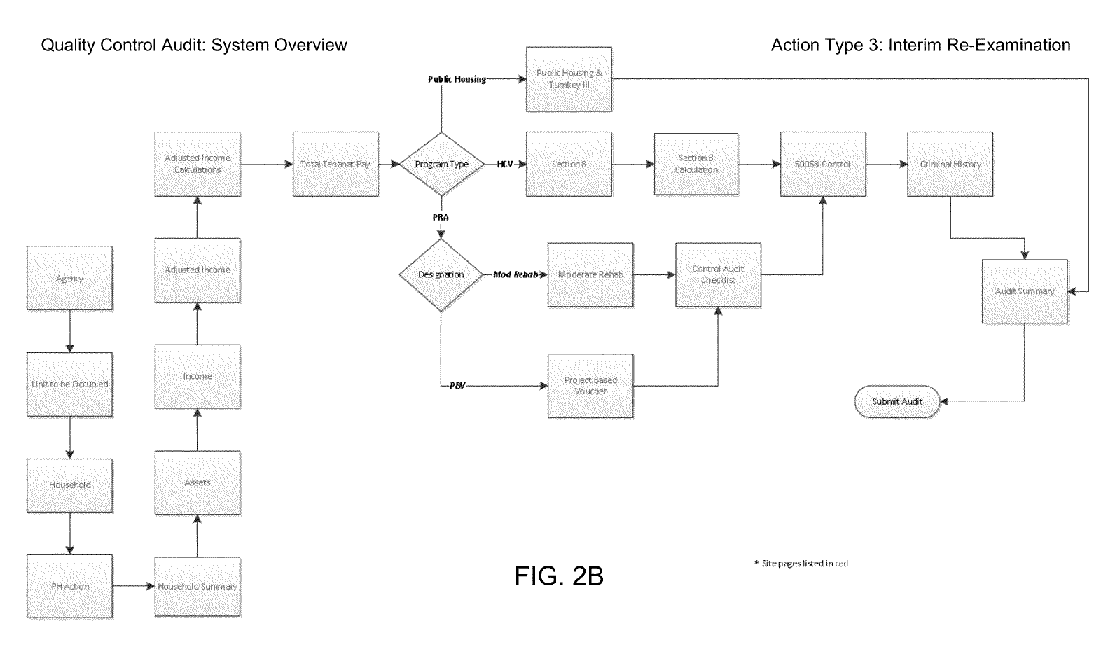

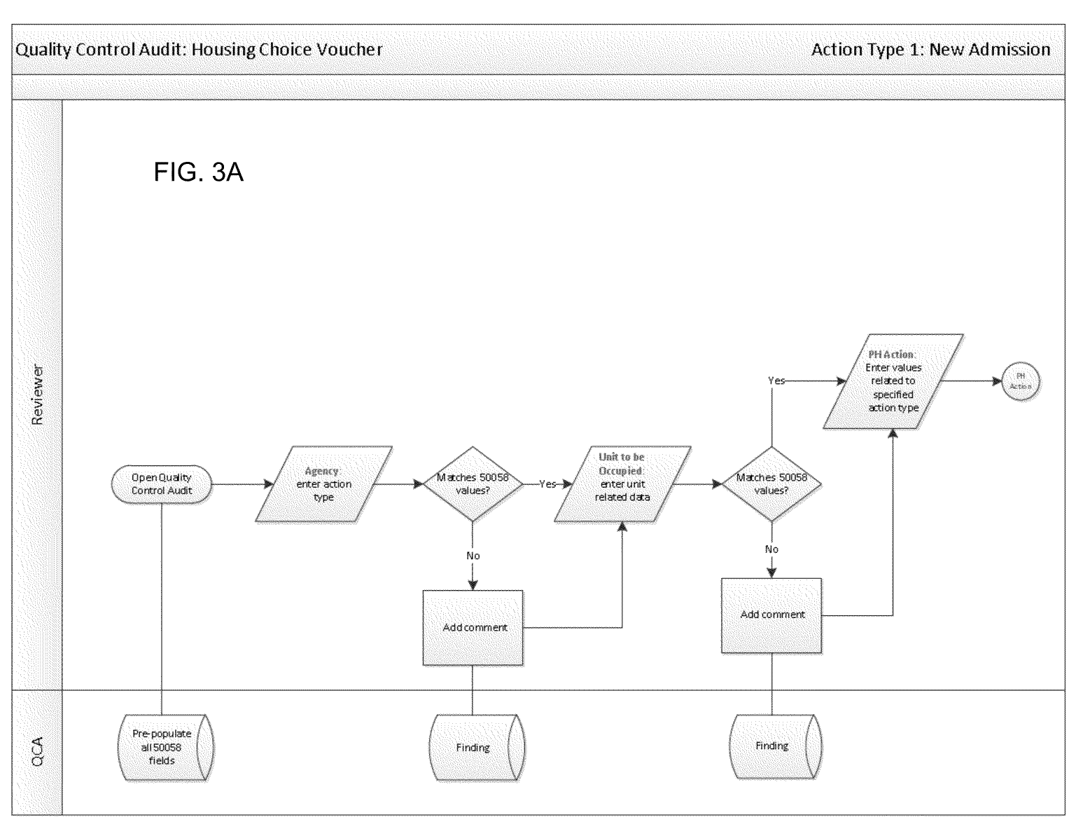

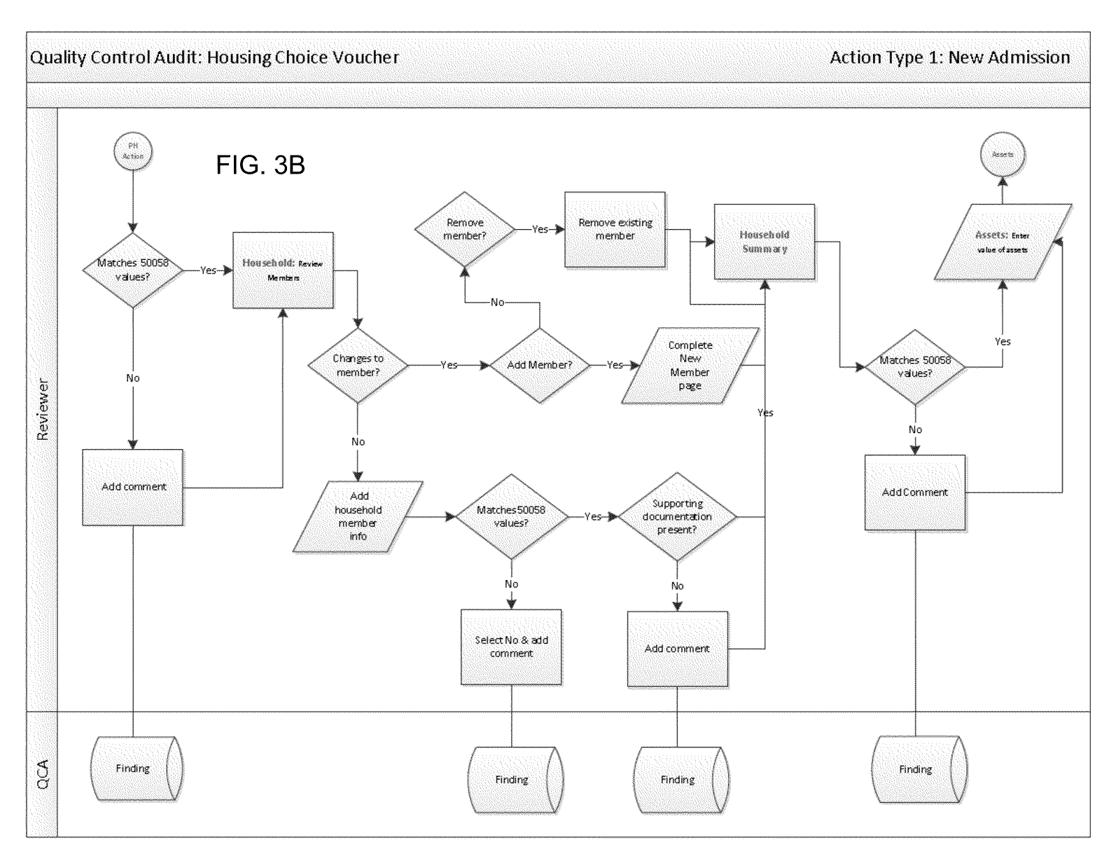

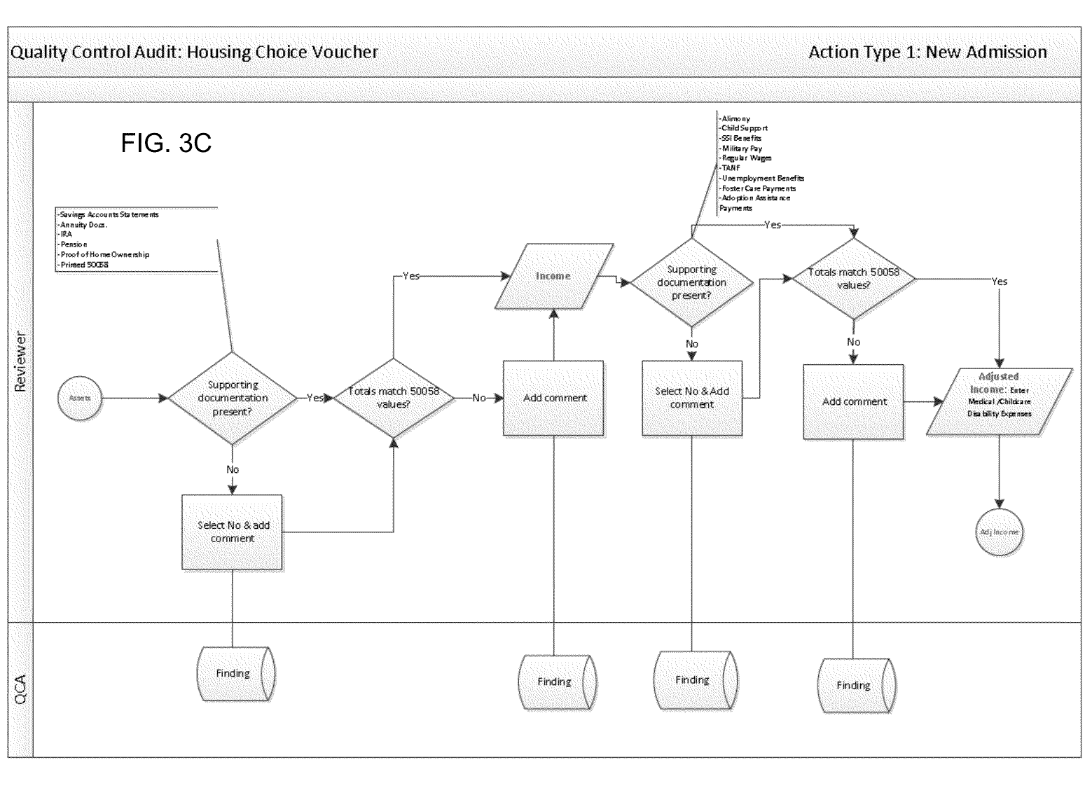

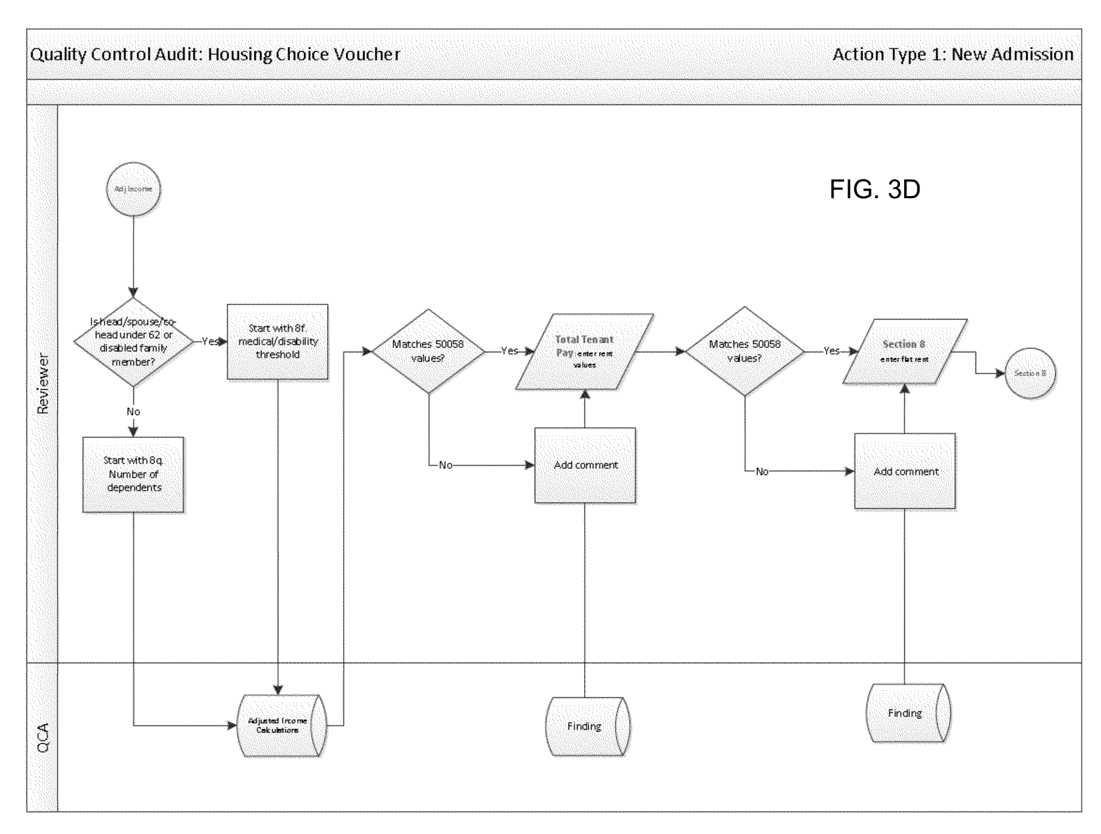

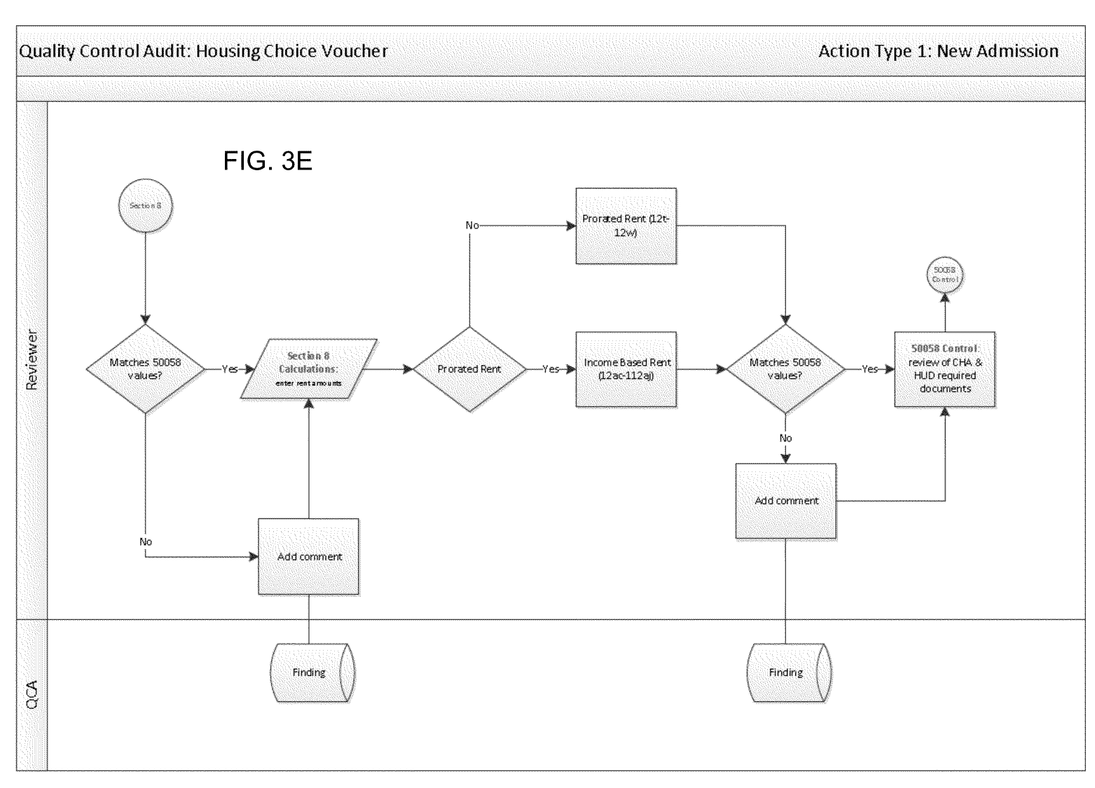

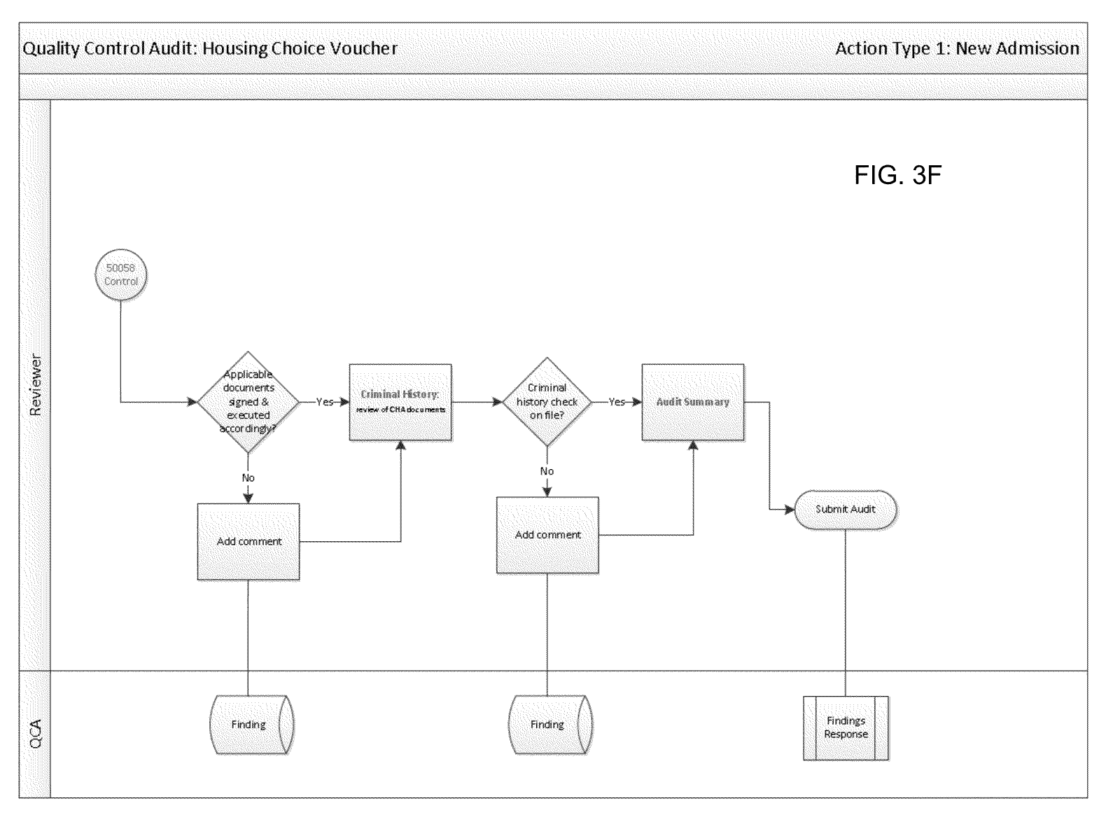

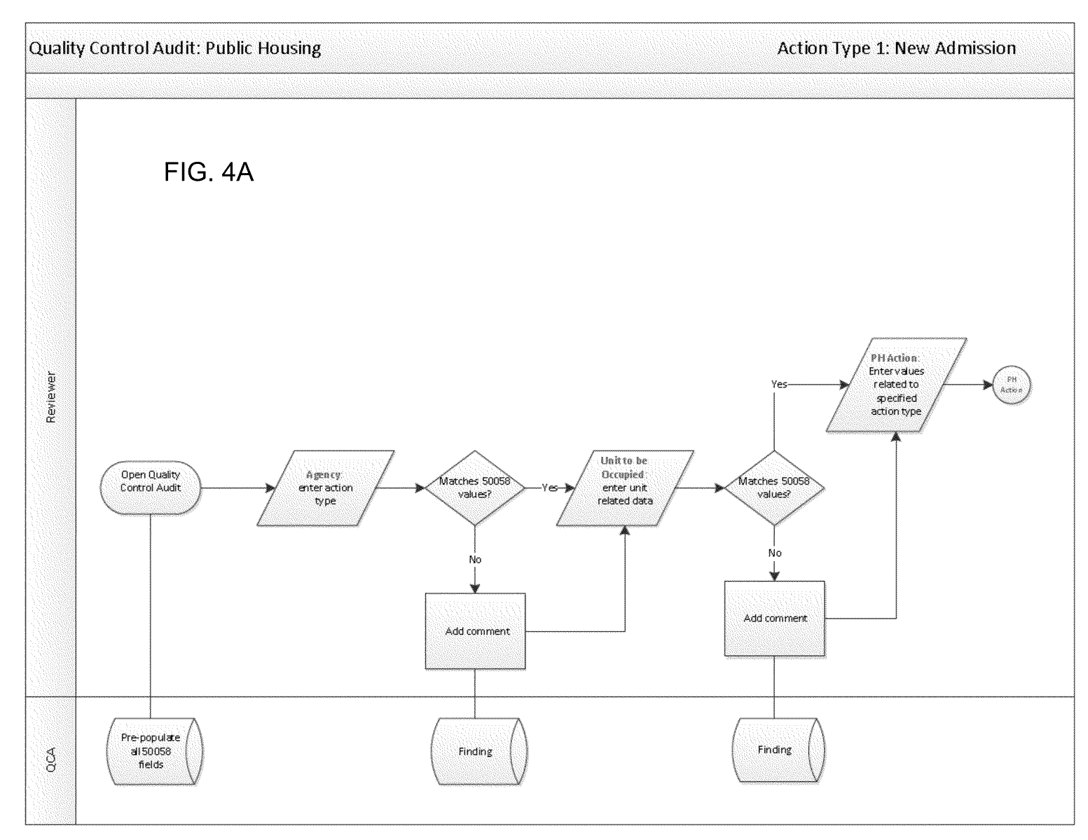

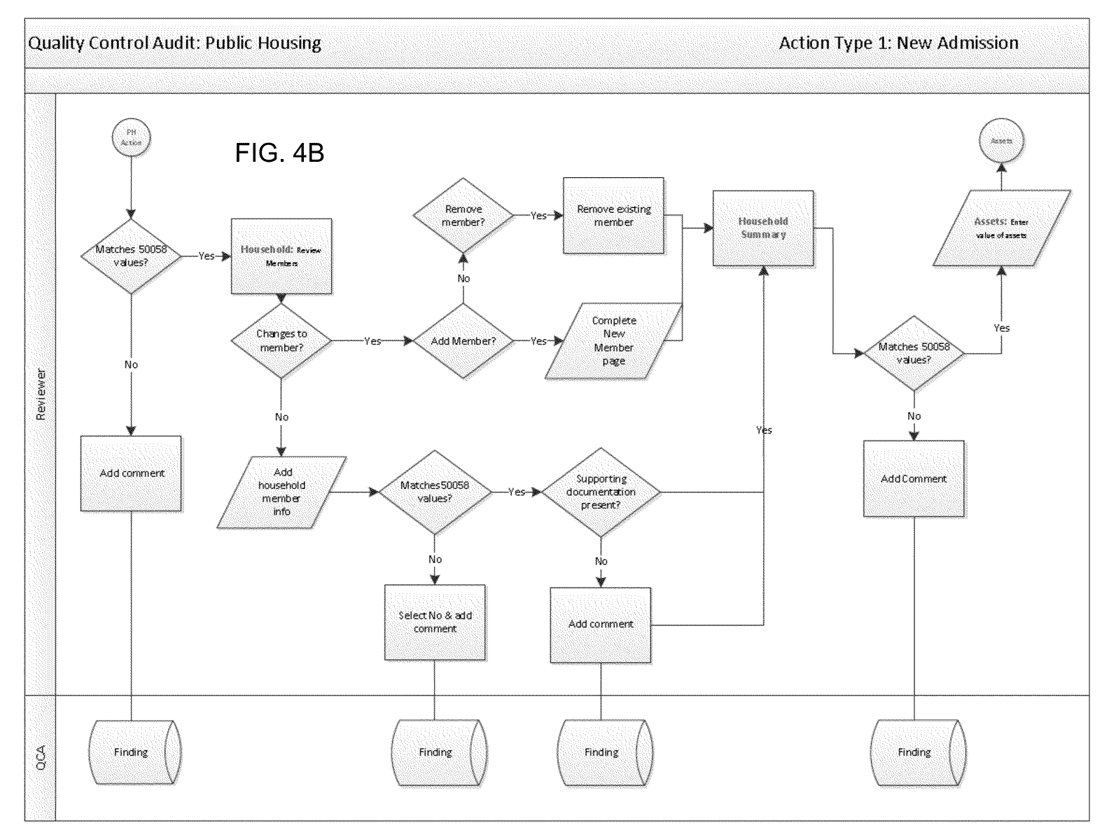

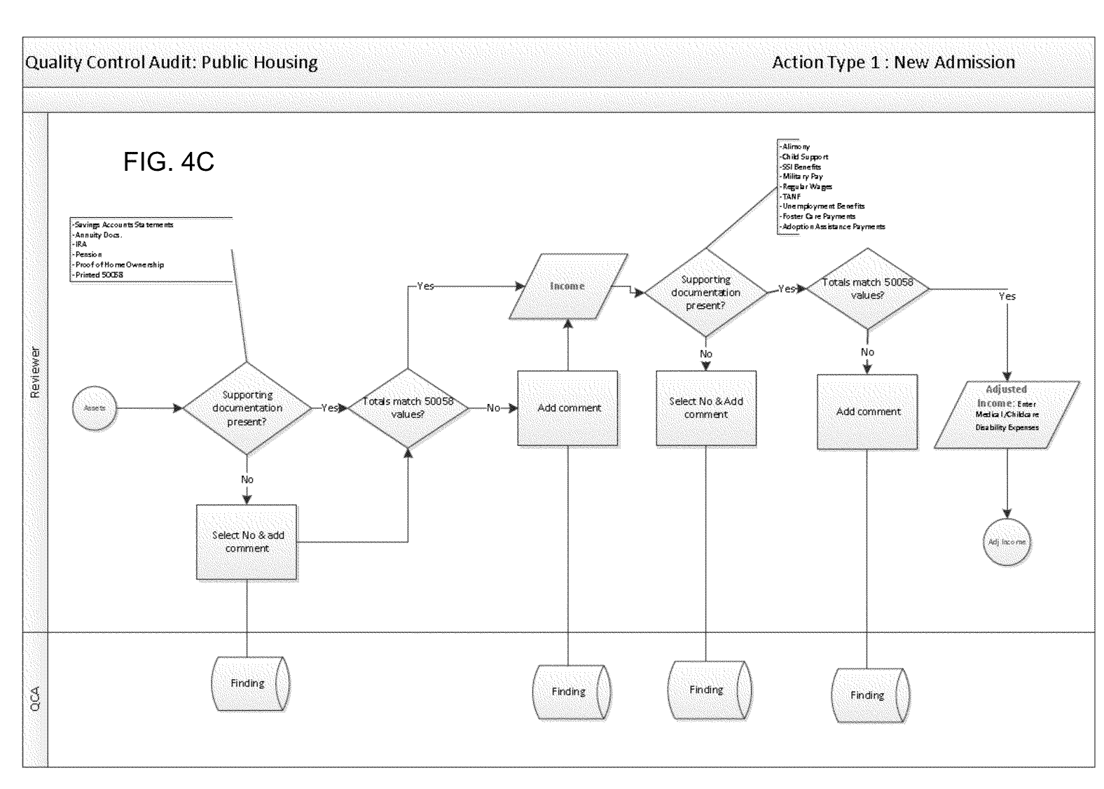

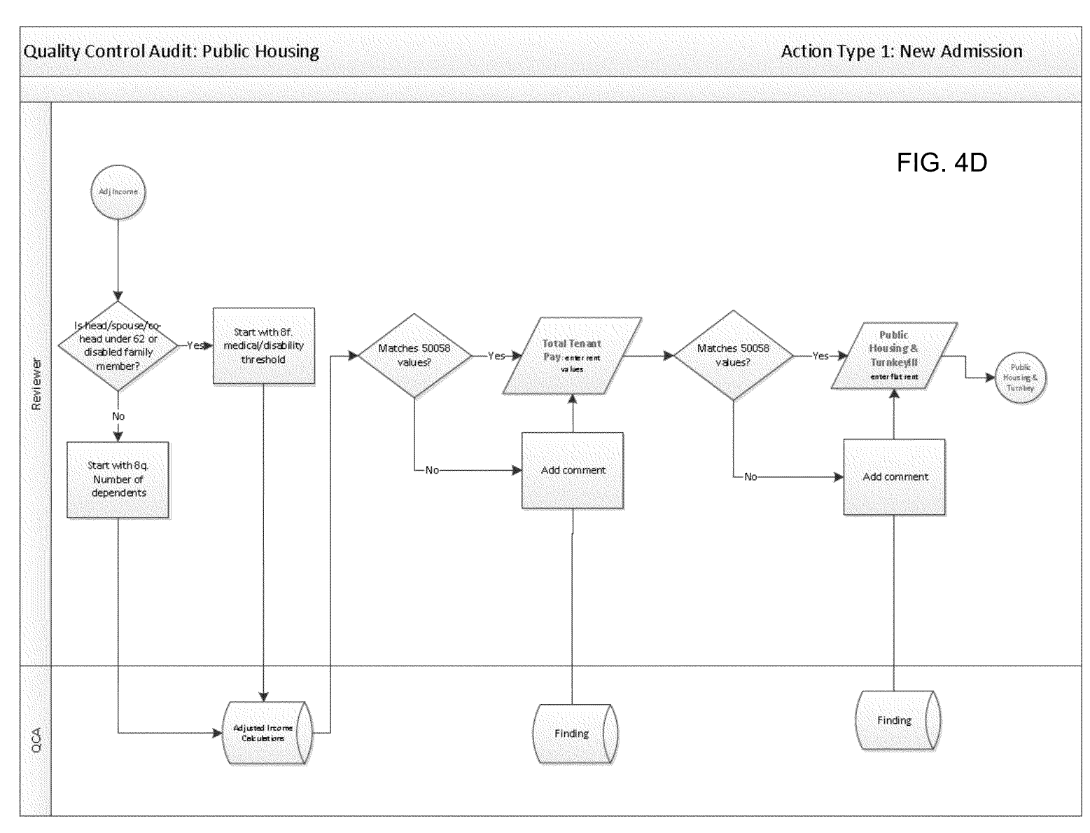

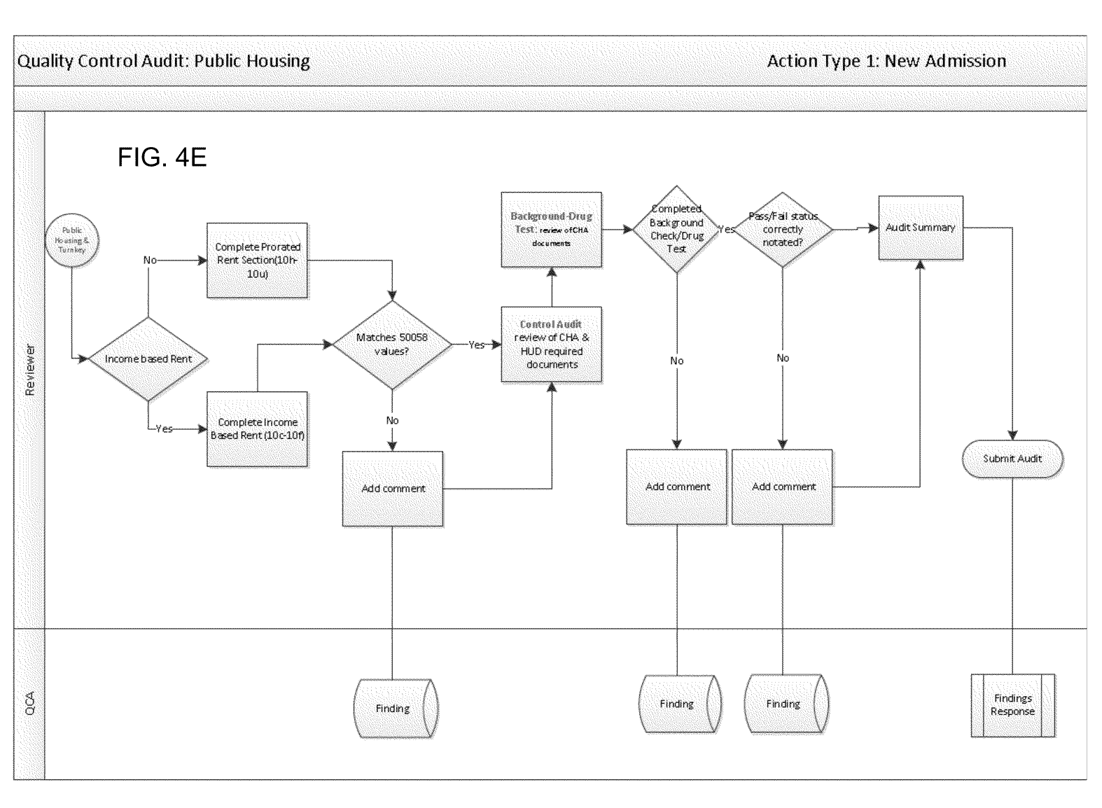

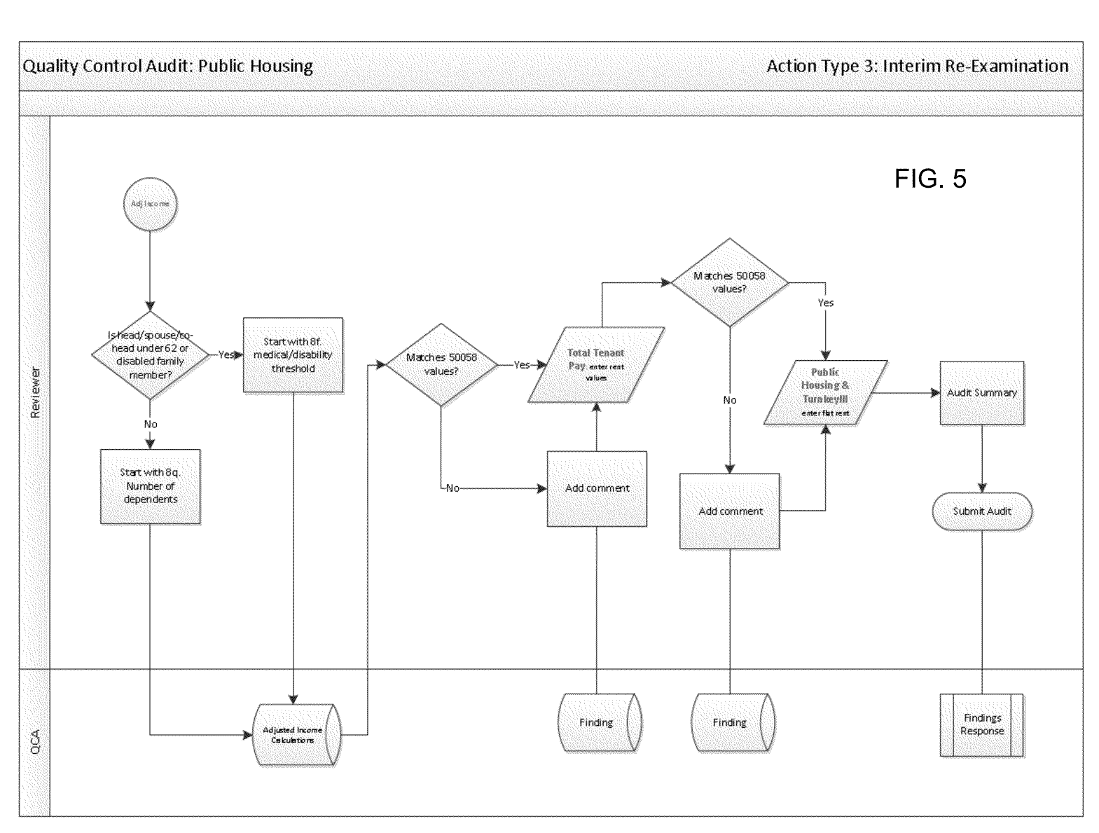

At this point the audit program of the system 10 selects the housing program type 20 associated with the selected tenant: (1) the Public Housing (PH) Audit 22 or the Housing Choice Voucher (HCV)/Property Rental Assistance (PRA) Audit 24. Alternatively, the audit application may allow for other types of audits (for example, other types of housing systems may have different tenant programs and thus audits of such programs). Once chosen, the reviewer completes the necessary audit as shown in the flow charts of FIGS. 2-5 (e.g., a Standard New Admission, a Standard Interim Reexamination, a New Admission Associated with a Housing Choice Voucher (HCV), a New Admission Associated with a Public Housing Action (PHA), and an Interim Reexamination Associated with a Public Housing Action (PHA)).

The system 10 provides for follow-up procedures 26 after initial findings are generated by the audit. If the audit indicates some findings against the vendor or PPM (e.g., errors or incomplete information in the current HUD form; missing documentation, additions or changes to the tenant, tenant assets or income; etc.) an electronic notification 28 identifying the findings is sent to the vendor or PPM. This can be done by e-mail or other electronic messaging systems. The vendor or PPM can then correct or dispute the findings 30 in a responsive electronic message 32 to the auditor. The reviewer or others at the Housing Authority can review the response 34. If the Housing Authority does not approve, a message is again sent to the vendor/PPM 30 which can then further attempt to correct or dispute the findings. These steps can be repeated until the Housing Authority accepts the response from the vendor/PPM or requires further action. Once the Housing Authority approves of the response the audit can be closed 36.

If there are no findings against the vendor/PPM, notification of the completed audit is electronically sent 38 to the vendor/PPM. The audit is then closed 40.

The flow-charts shown in the Figures provide an overview of the audit process. In operation, numerous screens and/or dialog boxes or windows are used in the program to walk the auditor or reviewer through the audit. Most of these screens have fields to be filled or checked by the auditor. Drop down menus are used to facilitate some of the reviewed items. The fields used in the audit are populated by the reviewer or can be automatically populated based on the values used in other fields. The program's screens include Agency Screens for a public housing resident, a Project Based Voucher (PBV) Resident, and/or a Housing Choice Voucher (HCV) Resident Screen; a Unit to be Occupied Screen; a Public Housing (PH) Action screen; a Household Screen (for adding or deleting family member); a Household Summary Screen; an Assets Screen; an Income Screen; an Adjusted Income Calculations Screen; a Total Tenant Pay (TTP) Screen; a Public Housing & Turnkey III Screen; a Project Based Voucher Screen; a Control Audit Checklist Screen; a 50058 Control Screen; a Section 8 Screen; a Section 8 Calculations Screen; a Criminal History Screen; a Control Audit Screen; a Continuous Quality Improvement Screen; and, a Background-Drug Test Screen.

It should be noted that the present audit system may be used in conjunction with and to check data entered into the Asset Management Software sold as “Voyager” provided by Yardi Systems, Inc., 430 South Fairview Avenue, Santa Barbara, Calif. 93117. Yardi Voyager™ is a fully-integrated, web-based, enterprise management system designed for property owners, managers, and investors in global real estate markets. The Yardi Voyager software is constructed to meet the specific requirements and metrics associated with multifamily housing, affordable housing, senior housing, and public housing. See http://www.yardi.com/US/YardiVoyagerFamily.aspx. The Yardi Voyager software provides an operating platform that centralizes accounting and property management data in a single database. This is meant to eliminate the need for data transfers and to enable the generation of up-to-the-minute reports.

The present invention's software while separate and distinct can act as an add-on module for the Yardi software but has the ability to interface with most 50058 compliant systems. Thus, a user/operator can sign in to the Yardi Asset Management Software and obtain standard Yardi reports or customized reports, all based on the information provided above.

The system 10 permits one to check to ensure all applicable answers on the 50058 Form are accurate and confirm all files and supporting documents are present. It further prompts the auditor for needed information or materials. The system completes all rental calculations based on client income and asset data inputted by the auditor. Additionally, it tracks all inputs and highlights discrepancies between the information of record (Yardi Voyager) and those items entered by the auditor. In particular, an auditor can navigate and assess individual case details and summaries and edit and comment thereto. Once completed, the Quality Control Audit application 10 generates a list of discrepancies that can be reviewed and disputed/corrected by the party responsible for maintaining the audited files. Discrepancies can be individually remedied while updates to the file are annotated in the system. The auditor, can then add further comments and verify and approve, or reject, any disputed/corrected items. Impact details for each case can also be generated and overall data or statistics of all or select cases can be generated.

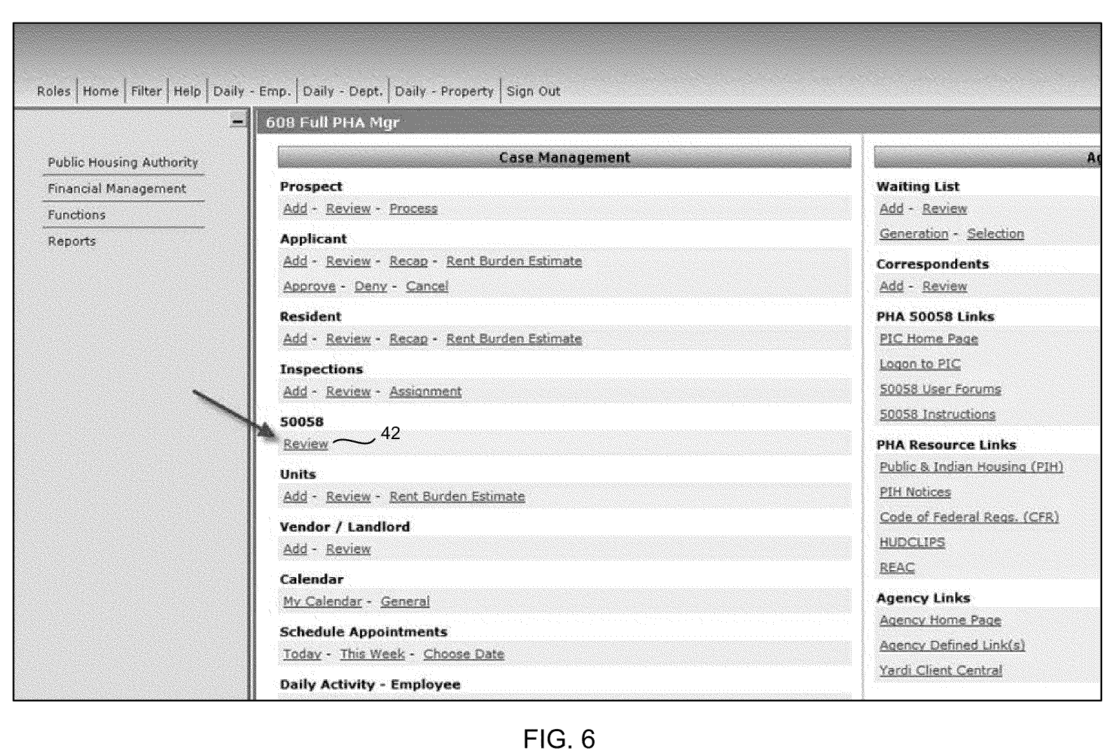

As mentioned above, an audit can be initiated from the Yardi application. This can be done by clicking on “review” 42 under the heading “50058” in the screen shot shown in FIG. 6. The application then provides for creation of an audit file for a particular tenant and associated property. Items of information from the tenant's current HUD-50058 form (i.e., each piece of data entered in the form—such as property address, resident names, ages, assets, income, etc.) are then populated in the audit file.

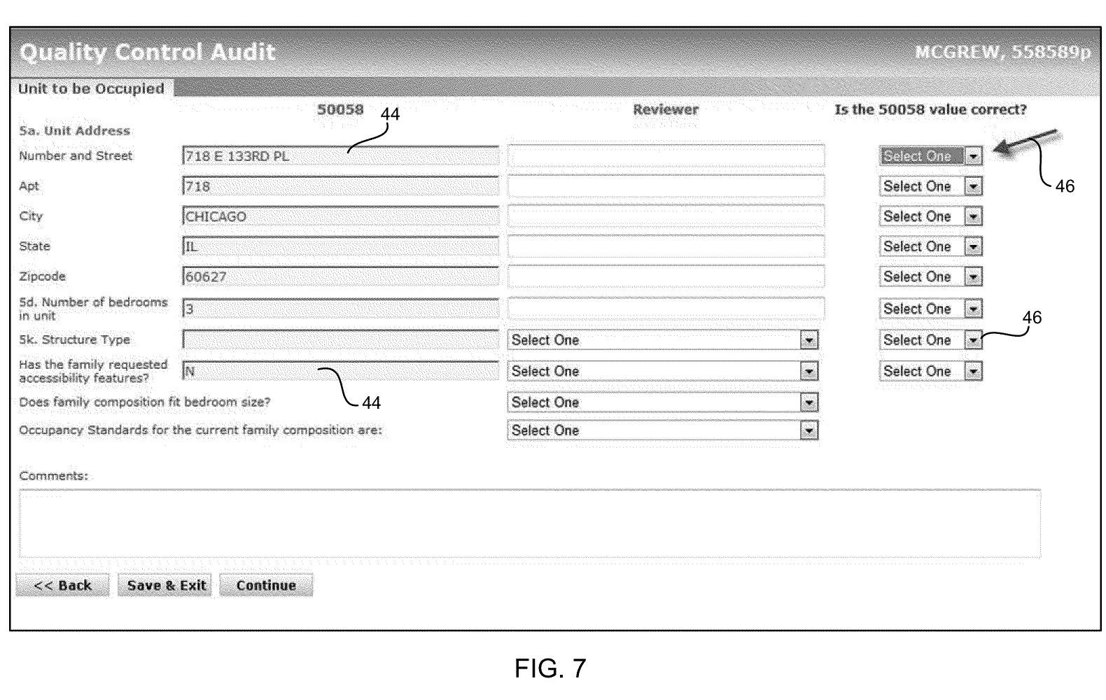

As shown in the screen shot of FIG. 7, the auditor can indicate whether each item of information 44 is correct or not correct by selecting an appropriate response from a corresponding drop down menu 46. The items of information in FIG. 7 are primarily directed toward identification of the housing unit.

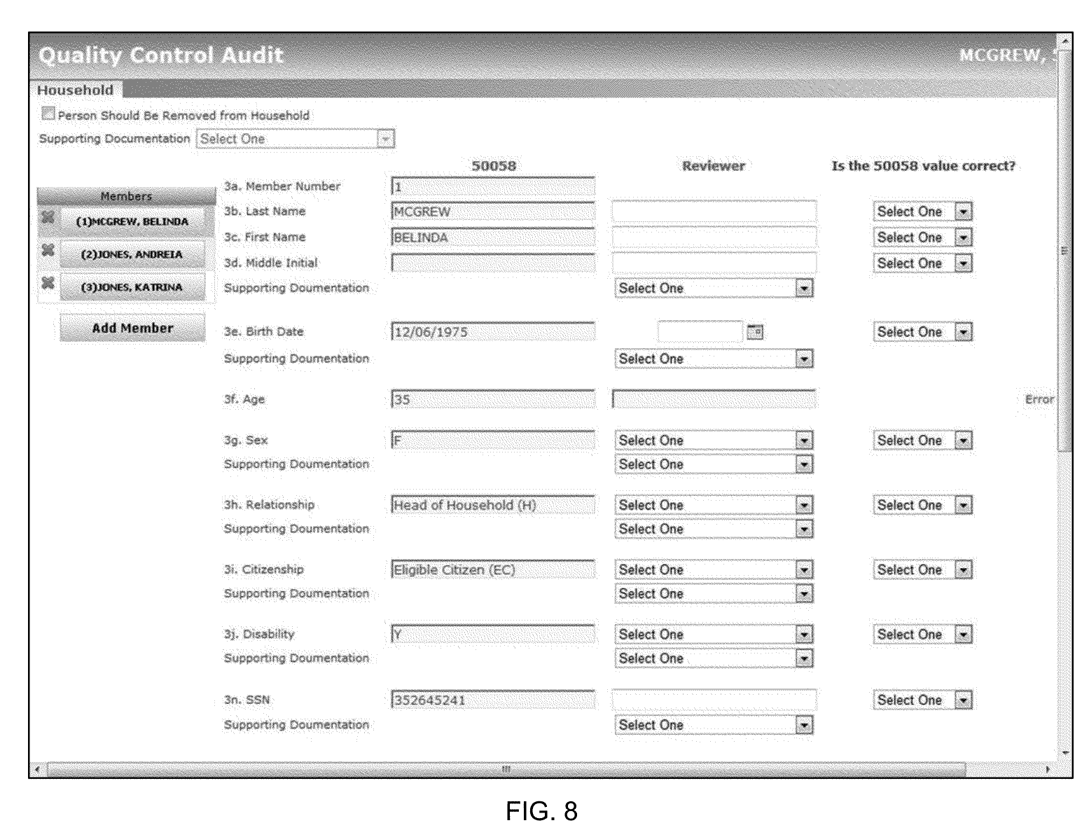

Other screens are used to guide the reviewer through other types of information in the HUD form. FIG. 8 is a screen shot relating to information concerning the members of the household for the particular tenant. The auditor can enter current information adding or deleting household members into the system 10 as appropriate.

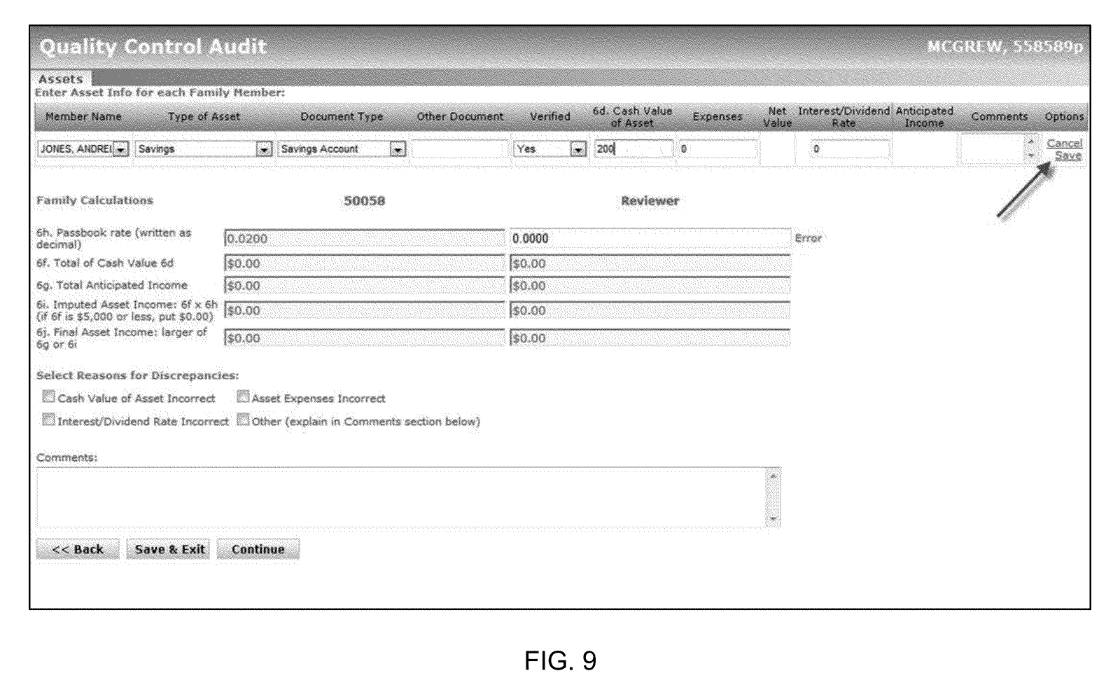

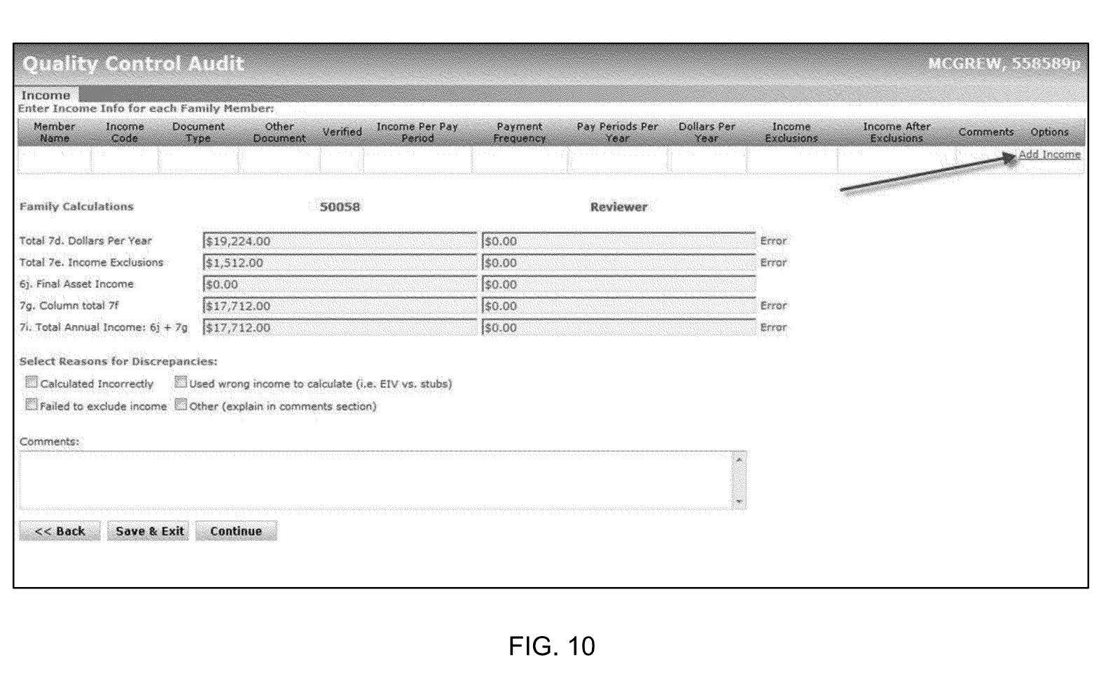

FIG. 9 is a screen shot relating to information concerning the assets of the tenant. FIG. 10 is a screen shot relating to information concerning the income of the tenant. The reviewer can enter current file information into these screens which the system 10 will compare with the HUD-50058 information.

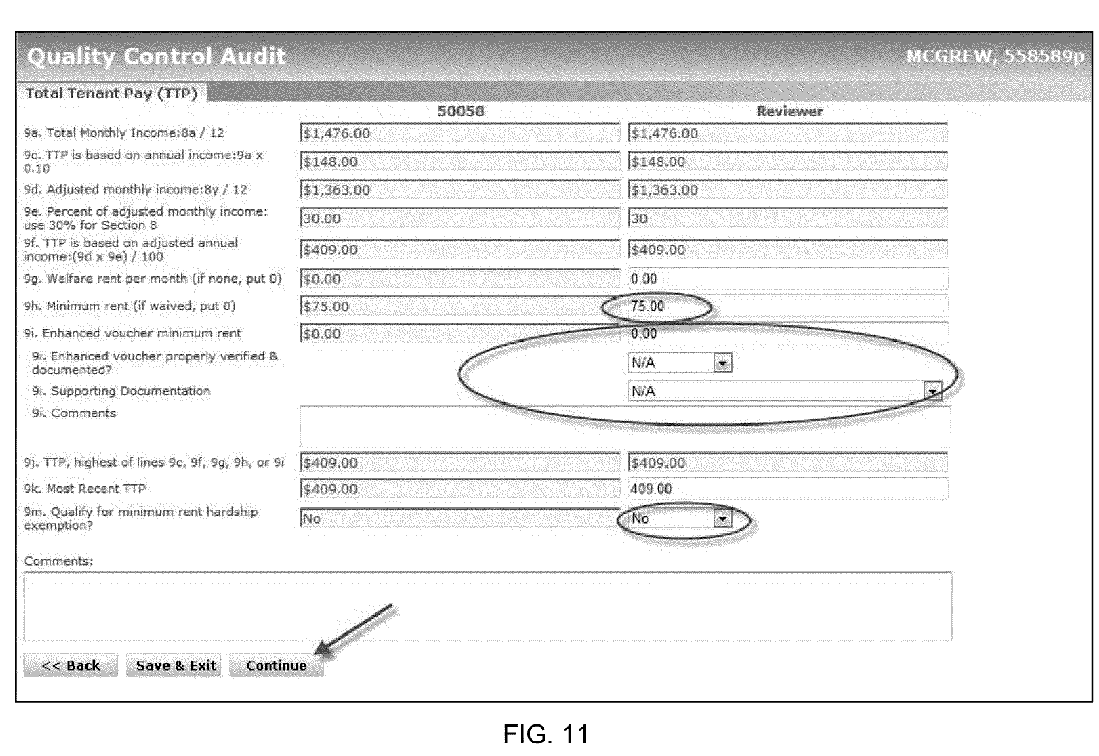

FIG. 11 shows a Total Tenant Pay screenshot. This screen compares information regarding rent paid by the tenant.

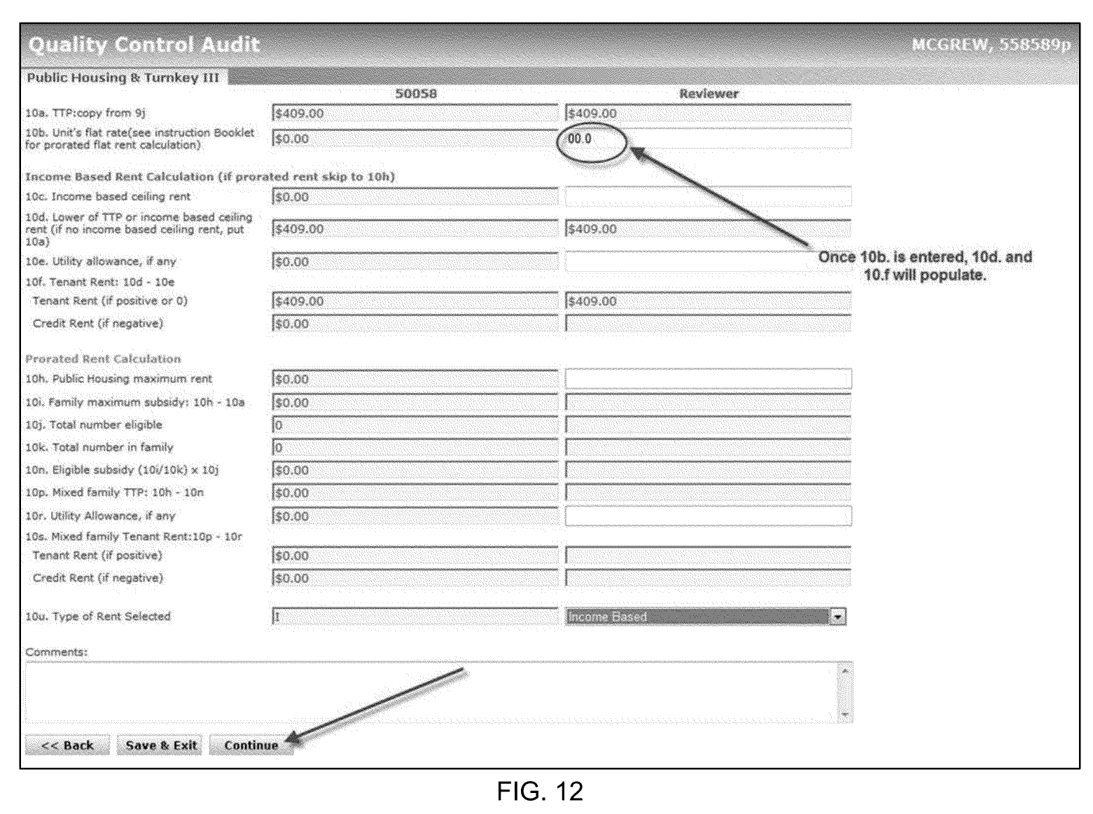

FIG. 12 shows a Public Housing & Turnkey screenshot. This screen will display if the tenant is a public housing resident.

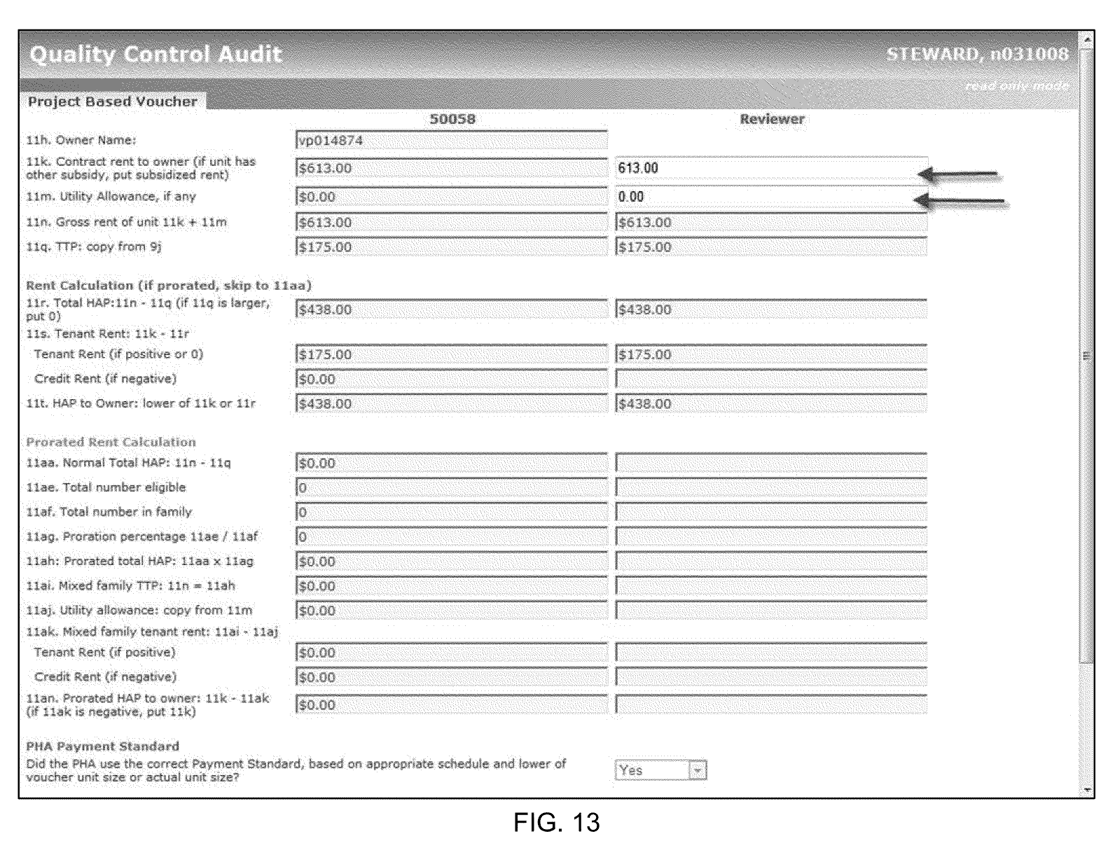

FIG. 13 is a Project Based Voucher screenshot. This screen requires the reviewer to enter certain values.

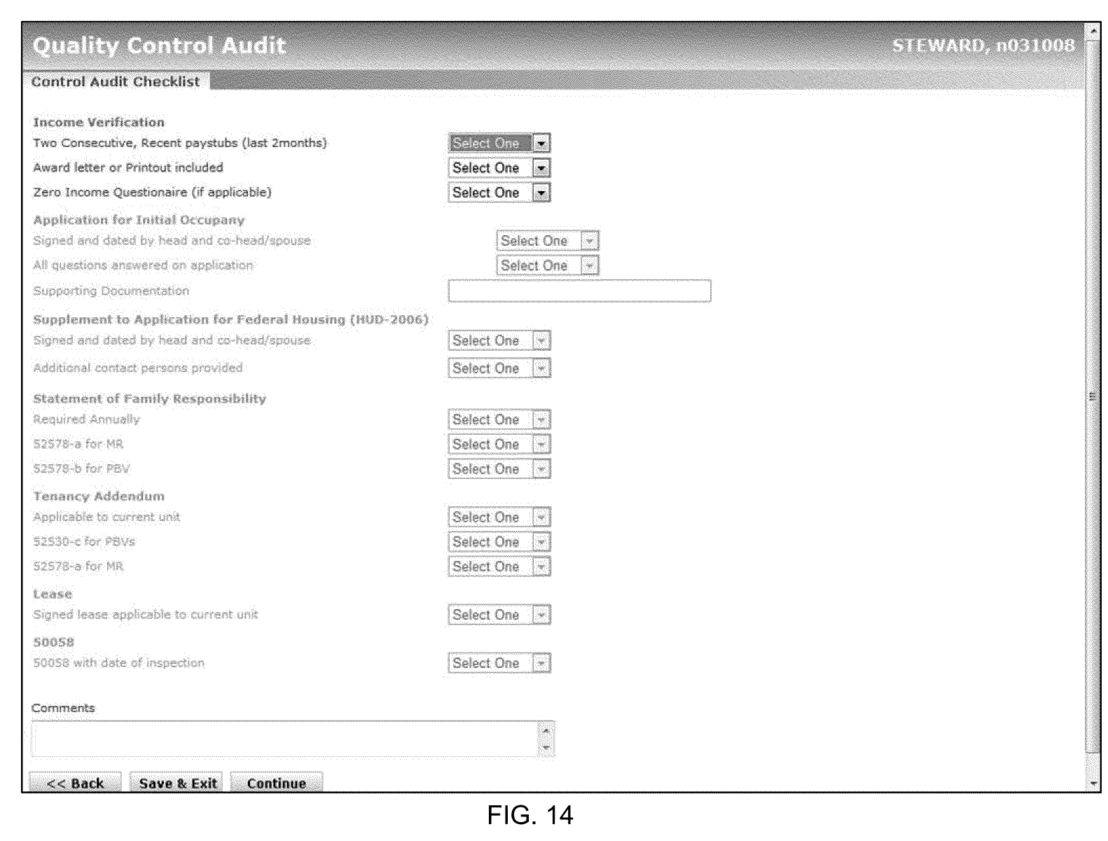

FIG. 14 is a Control Audit Checklist screenshot. This screen identifies certain documents that are required for the tenant.

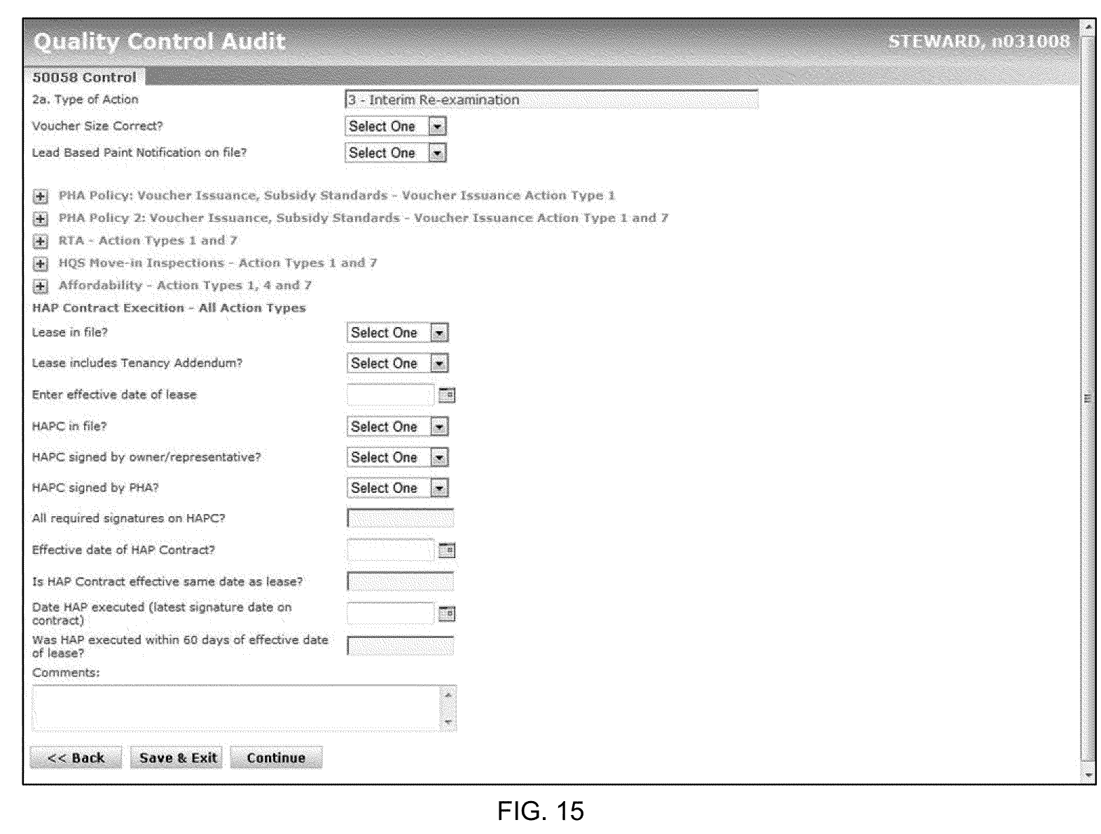

FIG. 15 shows a 50058 Control Screenshot. This screen walks the reviewer through documentation that should be in the file.

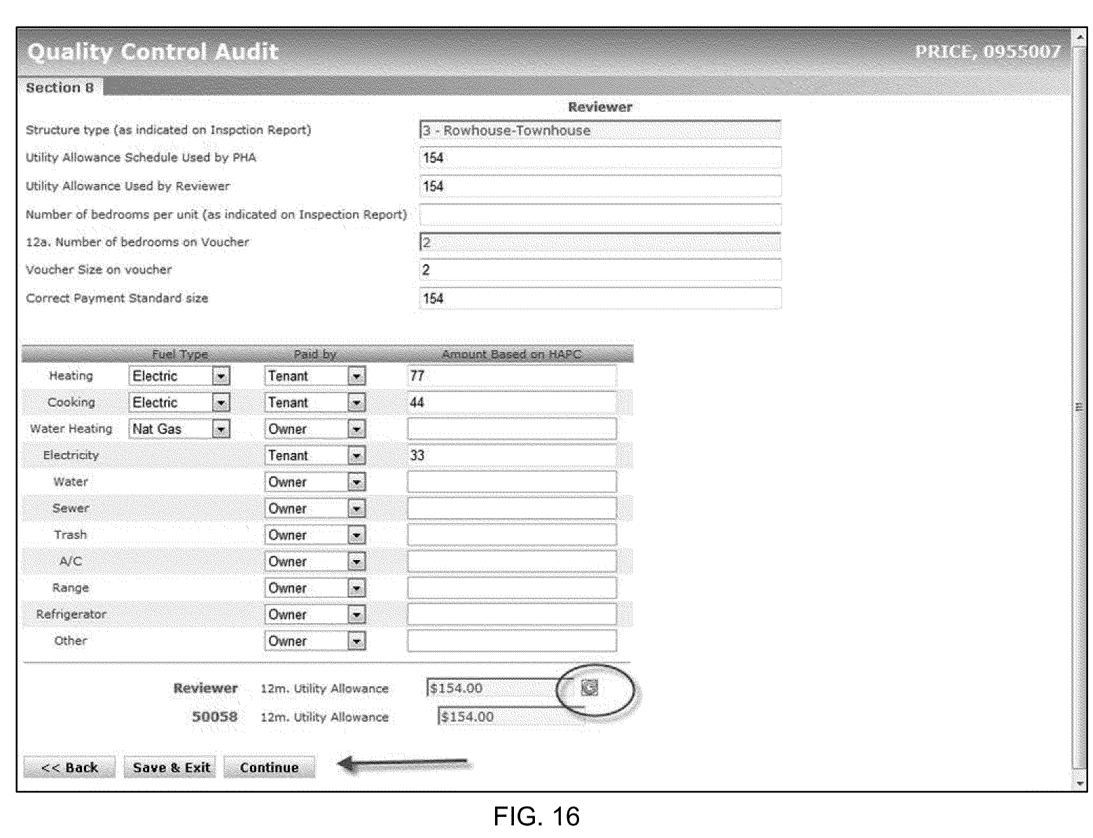

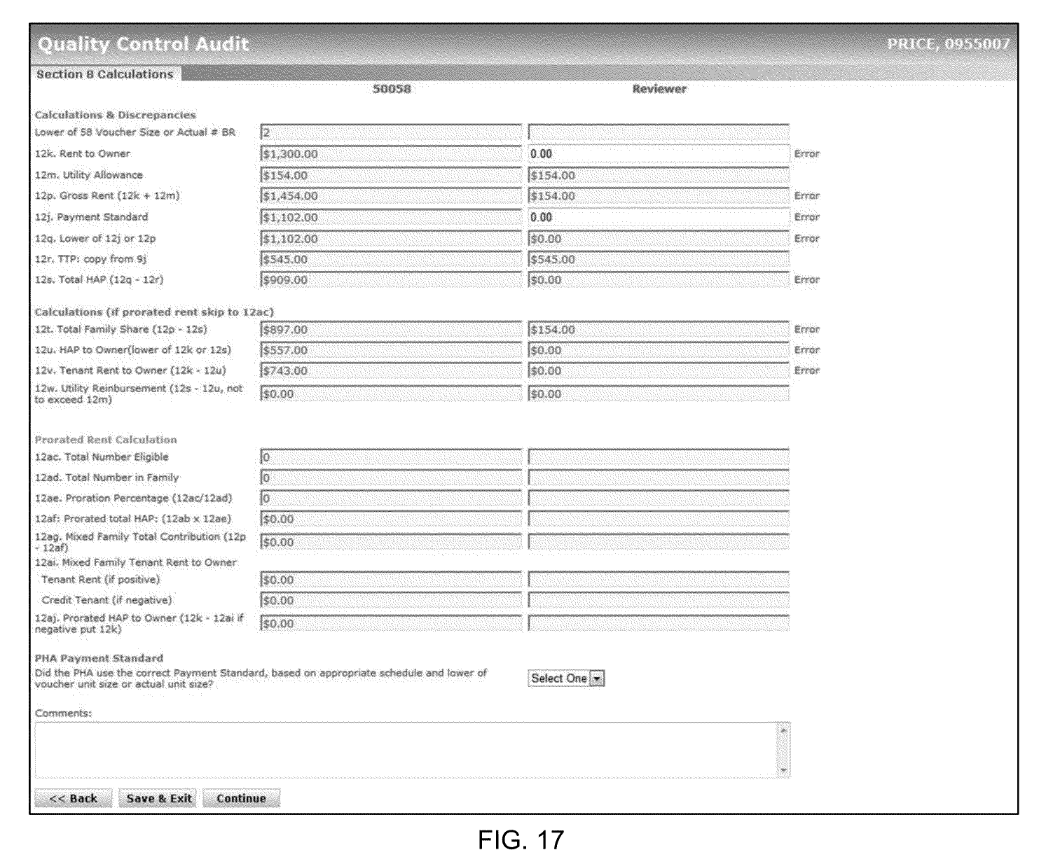

FIG. 16 shows a Section 8 screenshot. This screen is displayed by the system 10 if the audit is for a voucher resident. FIG. 17 provides a Section 8 Calculations screenshot.

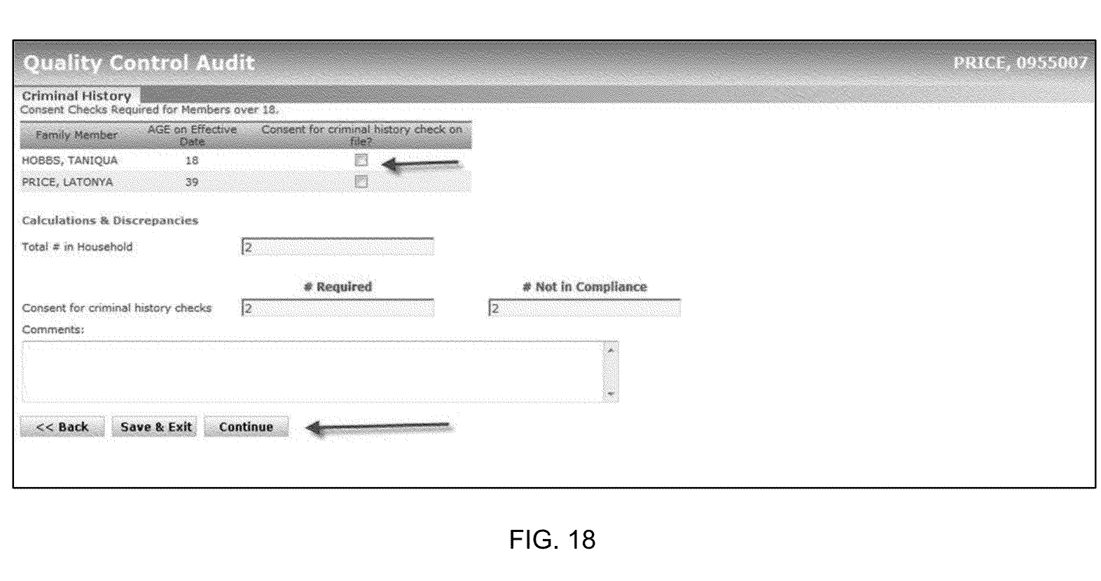

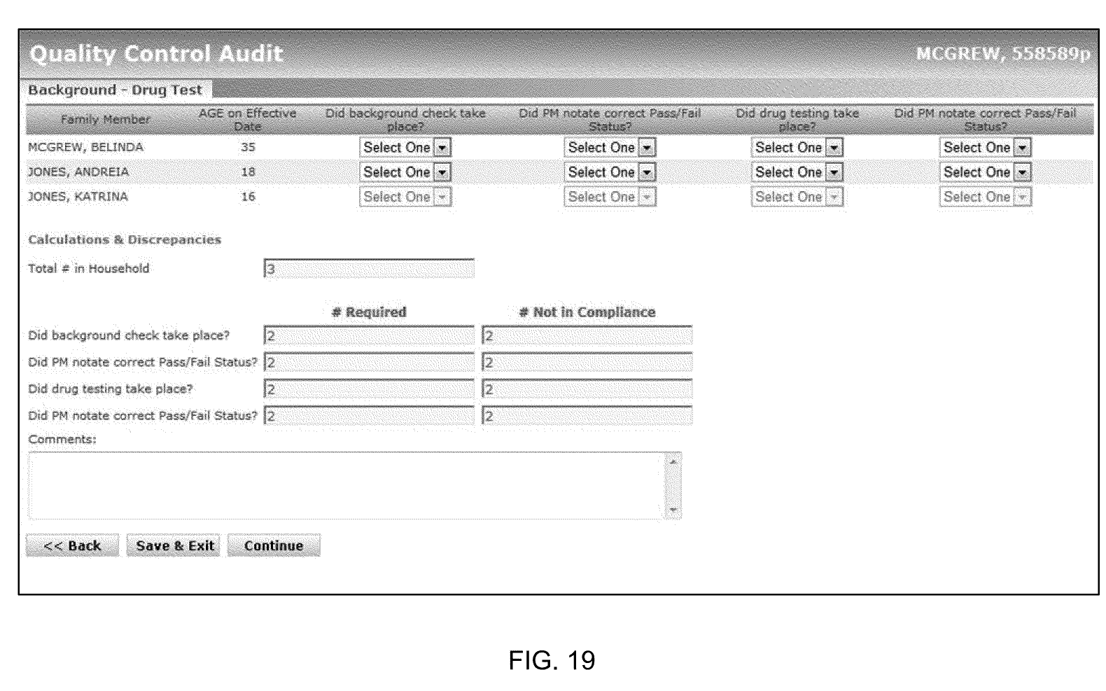

FIG. 18 shows a Criminal History screenshot. This screen applies to all household members eighteen years of age or older. FIG. 19 shows a Background-Drug Test screenshot.

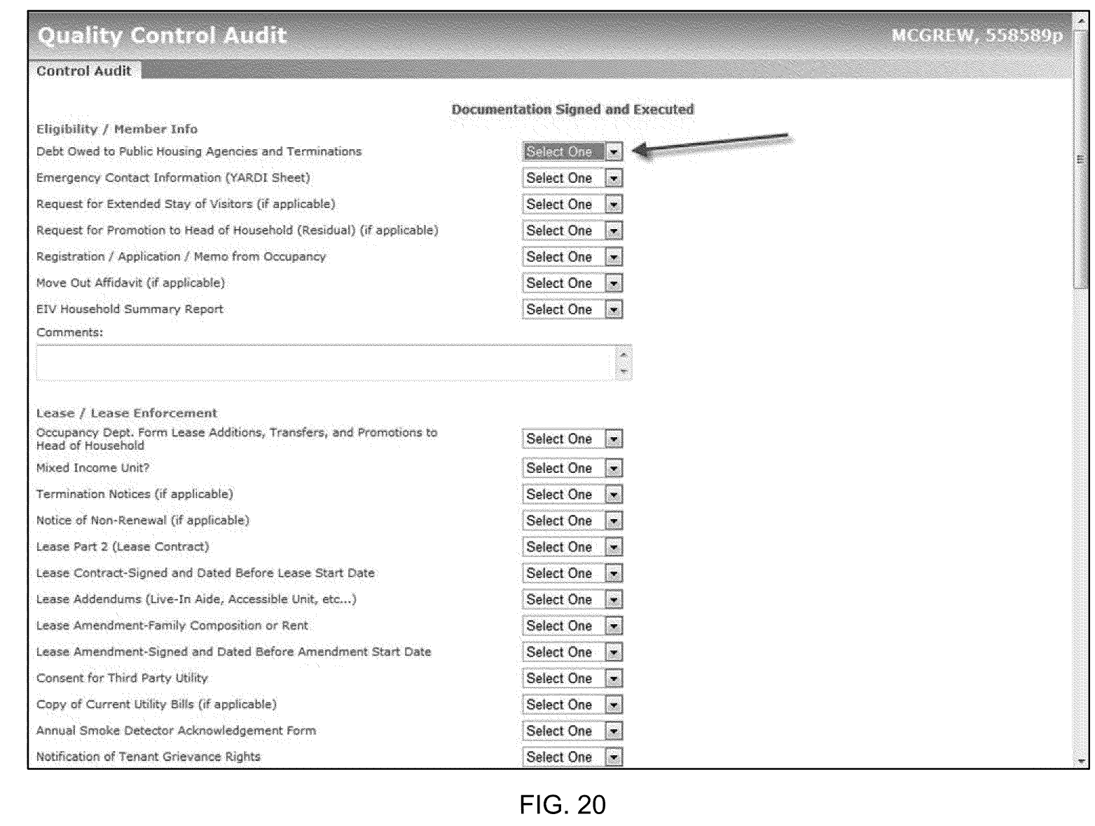

FIG. 20 shows a Control Audit screenshot. This screen will display for audits of public housing residents.

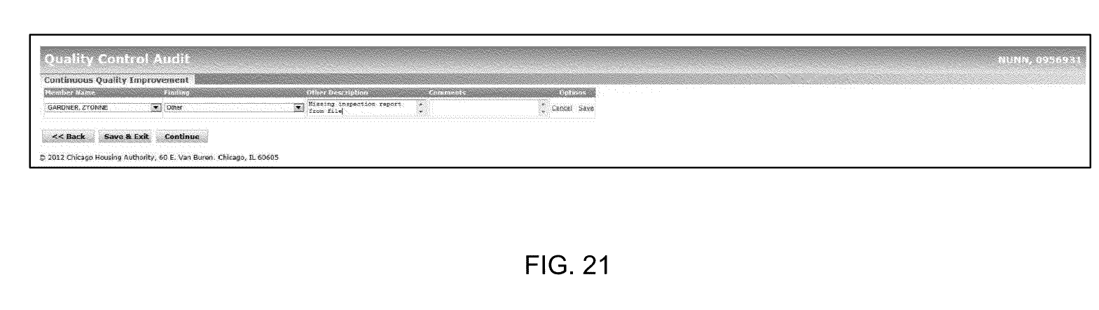

FIG. 21 shows a Continuous Quality Improvement page. This page can follow the criminal history check page in the audit.

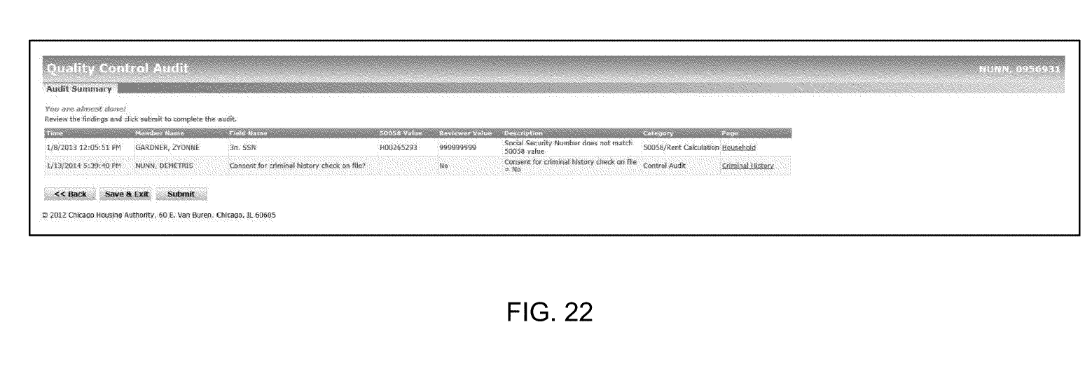

FIG. 22 shows an Audit Summary page. This provides a way for users of the system to review errors before submitting the audit.

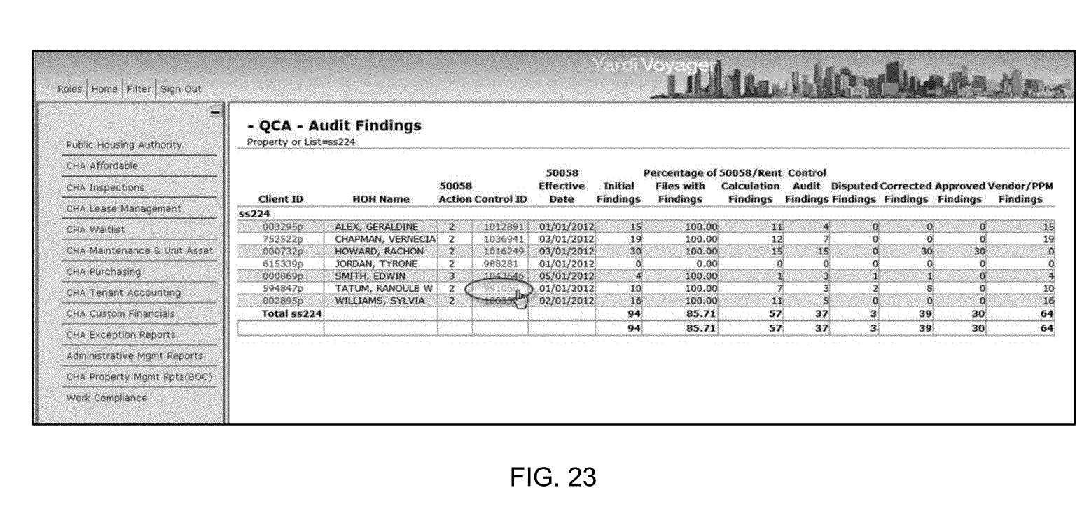

FIG. 23 shows an Audit Findings page. This page identifies the number of findings made during an audit.

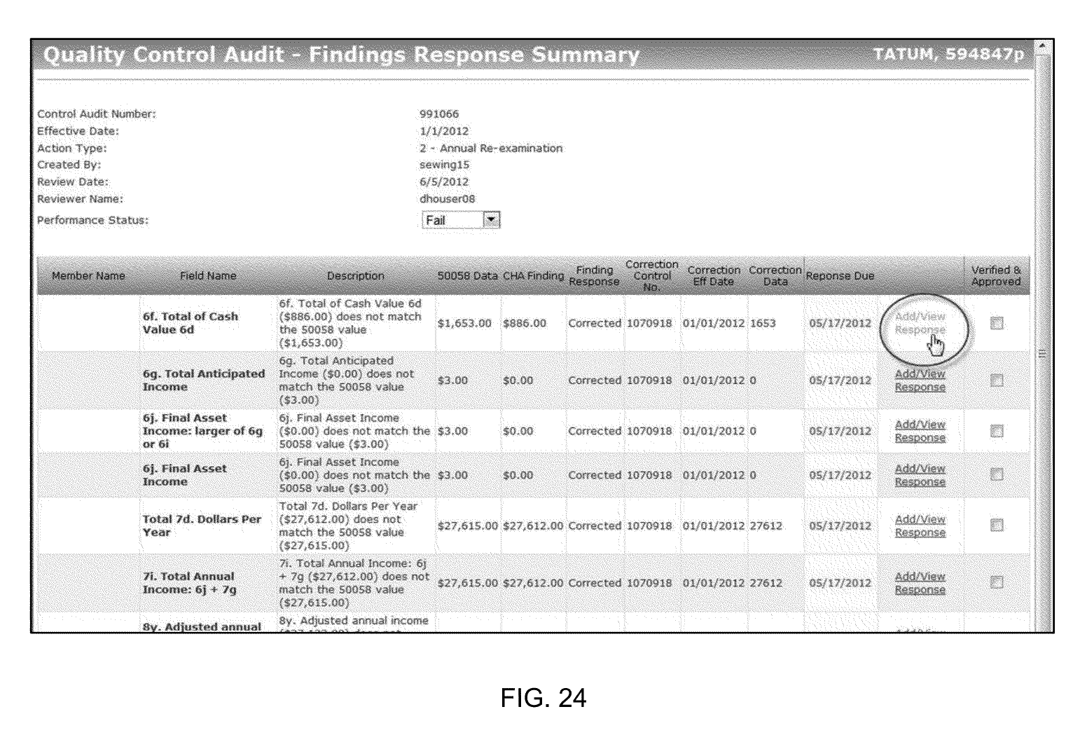

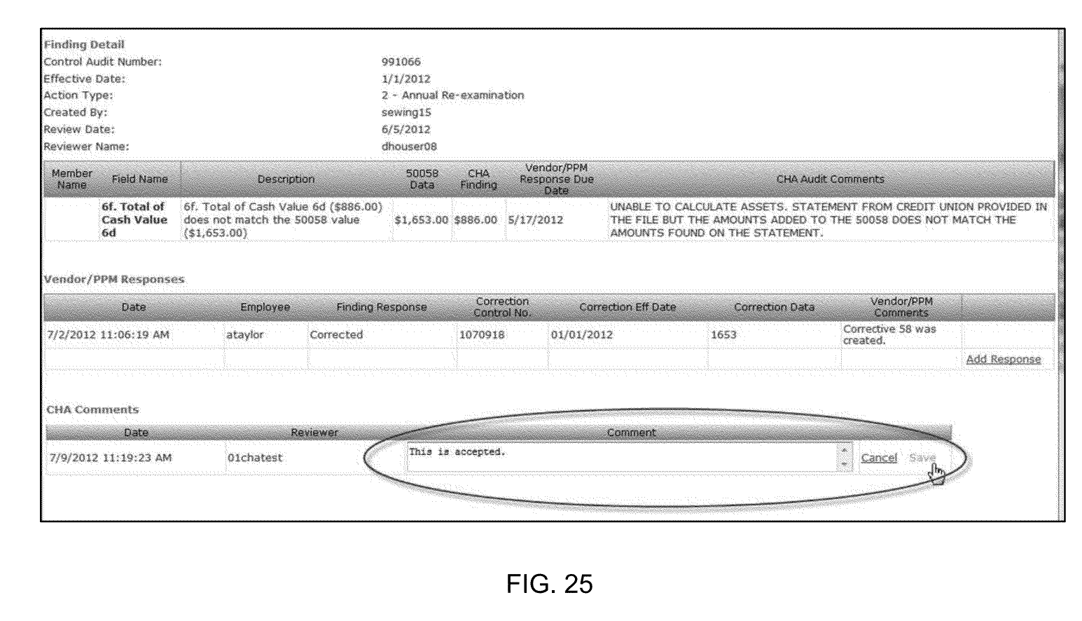

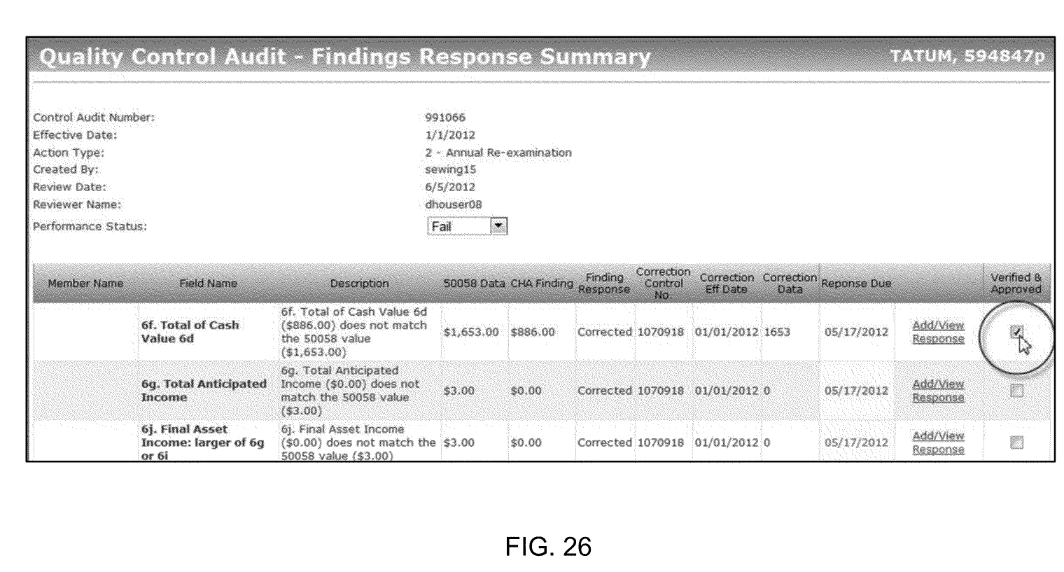

FIG. 24 shows a Findings Response Summary page. This page allows a user to view or add a response to a finding. The user can link to the detail from the Findings Response Summary page. FIG. 25 shows a comment in a Findings Response Detail page. FIG. 26 shows the Findings Response Summary page with a verified and approved check in a box for a finding.

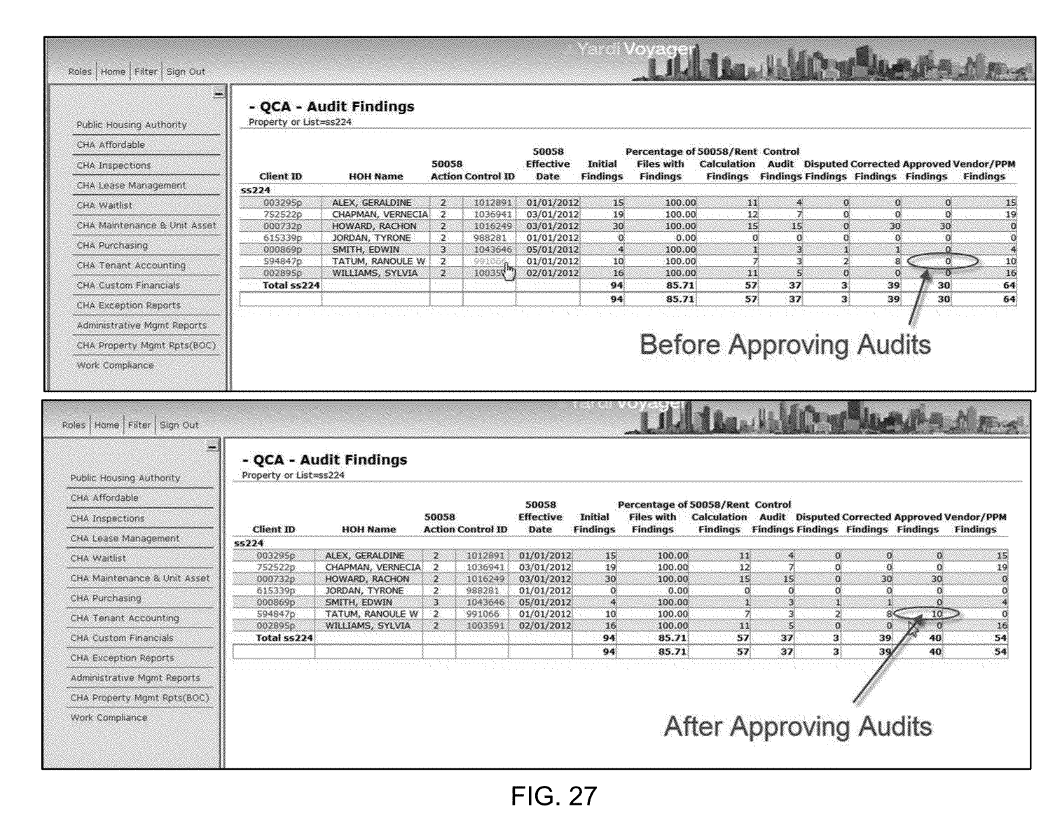

FIG. 27 shows an Audit Findings page before approval of the findings (on top) and one after approval of the findings (on the bottom).

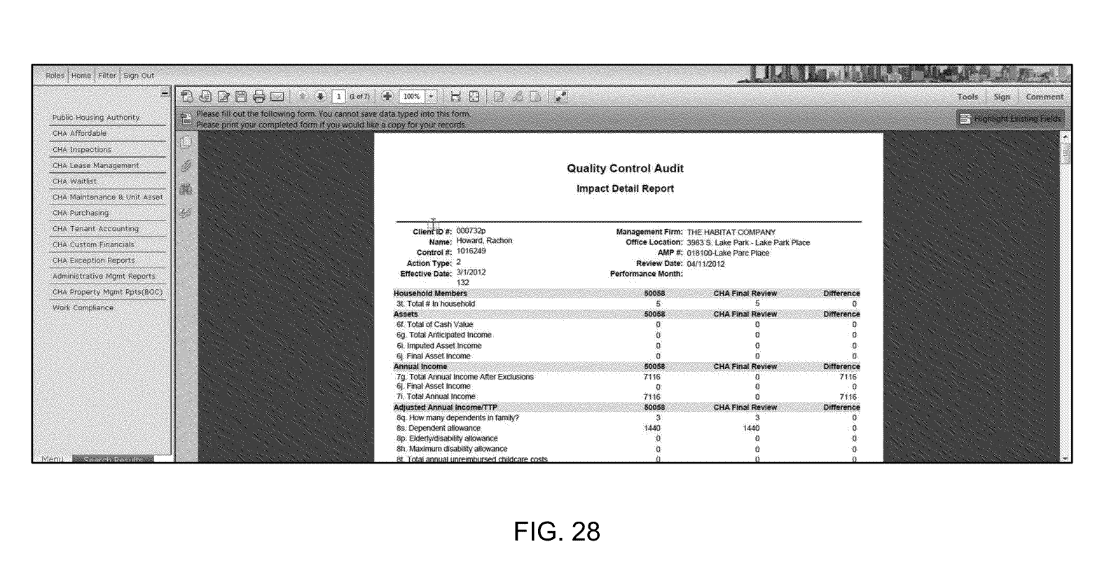

The system 10 can be used to generate a number of reports relating to the audits. FIG. 28 shows an Impact Detail Report.

Many modifications and variations of the present invention are possible in light of the above teachings. It is, therefore, to be understood within the scope of the appended claims the invention may be protected otherwise than as specifically described.

We claim:

1. A computerized housing audit system comprising:
a user computer configured to select a first tenant from a plurality of tenants in a subsidized housing program, wherein each of the plurality of tenants has an associated current electronically stored housing form containing required housing information;
the user computer configured to enable a user to initiate an electronic audit of the first tenant, the electronic audit including obtaining the current housing form containing the required housing information for the first tenant, enabling the user to confirm the accuracy of the required housing information of the first tenant, and generating a report identifying findings from the initiated audit.

2. The system of claim 1 wherein the user computer is configured to allow the user to select one of a Public Housing Audit and a Housing Choice Voucher (HCV)/Property Rental Assistance Audit based on the first tenant selected.

3. The system of claim 1 wherein the user computer is configured to enable the user to provide an indication that a select item of the required housing information of the first tenant is one of correct and not correct.

4. The system of claim 1 wherein the user computer is configured to enable the user to input file information relating to the first tenant and to compare the required housing information of the current electronically stored housing form to the inputted file information.

5. The system of claim 1 wherein the required housing information of the current electronically stored housing form of the first tenant includes an identification of a property leased by the first tenant.

6. The system of claim 1 wherein the required housing information of the current electronically stored housing form of the first tenant includes an identification of the household of the first tenant.

7. The system of claim 1 wherein the required housing information of the current electronically stored housing form of the first tenant includes an identification of assets of the first tenant.

8. The system of claim 1 wherein the required housing information of the current electronically stored housing form of the first tenant includes an identification of income of the first tenant.

9. The system of claim 1 wherein the required housing information of the current electronically stored housing form of the first tenant includes an identification of a criminal record of the first tenant.

10. The system of claim 1 wherein the user computer is configured to generate and send an electronic message to one of a vendor and private property management of the report identifying findings from the initiated audit.

11. The system of claim 10 wherein the user computer is configured to receive an electronic message from the one of a vendor and private property management responding to the report identifying findings from the initiated audit.

12. The system of claim 11 wherein the responding electronic message is one of a correction of the required information of the first tenant or a dispute of the inaccuracy of the required information of the first tenant.

13. The system of claim 4 wherein the user computer is configured to calculate a tenant rent rate based at least in part on the user inputted file information.

14. The system of claim 1 wherein the user computer is configured to identify requisite supporting documentation for the required information of the first tenant.

15. The system of claim 1 wherein the housing form is a HUD-50058 form.

16. An electronic housing auditing process comprising:
providing a user computer in communication with a database of a plurality of current tenant housing forms of a corresponding plurality of tenants in a subsidized housing program, each tenant housing form containing a plurality of items of information;
selecting a first tenant of the plurality of tenants;
enabling a reviewer to initiate an electronic audit of the selected first tenant;
obtaining a tenant housing form associated with the selected tenant from the database;
reviewing the items of information from the obtained tenant housing form; and,
generating a report containing findings of the reviewing step.

17. The electronic housing auditing process of claim 16 wherein said reviewing step comprises:
displaying an item of information from the obtained tenant housing form;
receiving an electronic response from the reviewer indicating the selected item is one of correct or incorrect.

18. The electronic housing auditing process of claim 16 wherein said reviewing step comprises:
receiving inputted data from the reviewer;
electronically comparing the inputted data against an item of information from the obtained tenant housing form.

19. The electronic housing audit process of claim 16 further comprising:
electronically transmitting the report to one of a vendor and a private property management associated with the tenant;
electronically receiving one of a correction and a dispute of the findings in the report.

20. The electronic housing audit process of claim 19 further comprising electronically tracking the status of the findings in the report.
